(19) United States
(12) Patent Application Publication
(10) Pub. No.: US 2018/0324631 A1
(43) Pub. Date: Nov. 8, 2018

(54) USING SDAP HEADERS FOR HANDLING OF AS/NAS REFLECTIVE QOS AND TO ENSURE IN-SEQUENCE PACKET DELIVERY DURING REMAPPING IN 5G COMMUNICATION SYSTEMS

(71) Applicant: Mediatek Inc., Hsin-Chu (TW)

(72) Inventors: Yu-Syuan Jheng, Hsinchu (TW); Pavan Santhana Krishna Nuggehalli, San Jose, CA (US); Chia-Chun Hsu, Hsinchu (TW)

(21) Appl. No.: 15/971,093

(22) Filed: May 4, 2018

Related U.S. Application Data
(60) Provisional application No. 62/501,917, filed on May 5, 2017.
(60) Provisional application No. 62/544,107, filed on Aug. 11, 2017.
(60) Provisional application No. 62/564,388, filed on Sep. 28, 2017.
(60) Provisional application No. 62/565,232, filed on Sep. 29, 2017.
(60) Provisional application No. 62/565,234, filed on Sep. 29, 2017.

(51) Int. Cl. H04W 28/02; H04W 36/00; H04W 36/08; H04W 72/12; H04W 72/02; H04W 76/27; H04W 68/02; H04W 72/04; H04L 5/00; H04W 36/16

(52) U.S. Cl. CPC H04W 28/0263; H04W 28/0268; H04W 36/0016; H04W 36/08; H04W 72/1263; H04W 72/02; H04L 1/1812; H04W 68/02; H04W 36/0022; H04W 72/042; H04L 5/0055; H04W 36/165; H04W 76/27

(57) ABSTRACT

In an aspect of the disclosure, an apparatus is provided. The apparatus receives a downlink data packet and determines a service data flow associated with the downlink data packet. The apparatus extracts, from the downlink data packet, a Non-Access Stratum (NAS) Reflective QoS Indication (RQI) indicator that instructs the UE to map a service data flow to the QoS flow. The apparatus further extracts, from the downlink data packet, a Quality of Service (QoS) flow identifier identifying a QoS flow. The apparatus generates a first NAS mapping that maps the service data flow to the QoS flow, in response to a determination that the service data flow is not mapped to the QoS flow at the apparatus. The apparatus further transmits, in accordance with the first NAS mapping, an uplink data packet associated with the service data flow through the QoS flow.

### CROSS-REFERENCE TO RELATED APPLICATION(S)

This application claims the benefit of U.S. Provisional Application Ser. No. 62/501,917 entitled “Handling of Reflective Mapping in Mobile Communication Systems” and filed on May 5, 2017, U.S. Provisional Application Ser. No. 62/544,107 entitled “SDAP Header Design for 5G QoS” and filed on Aug. 11, 2017, U.S. Provisional Application Ser. No. 62/564,383 entitled “Handling of RQI for 5G QoS” and filed on Sep. 28, 2017, U.S. Provisional Application Ser. No. 62/564,388 entitled “SDAP Header Design to Ensure In-Order Delivery During 5G QoS Remapping” and filed on Sep. 28, 2017, U.S. Provisional Application Ser. No. 62/565,232 entitled “SDAP Header Design to Ensure In-Order Delivery During 5G QoS Remapping” and filed on Sep. 29, 2017 and U.S. Provisional Application Ser. No. 62/565,234 entitled “Handling of RQI for 5G QoS” and filed on Sep. 29, 2017, which are expressly incorporated by reference herein in their entirety.

### BACKGROUND

### Field

The present disclosure relates generally to mobile communication systems, and more particularly, to user equipment (UE) that supports utilization of Service Data Adaptation Protocol (SDAP) headers for handling Application Service (AS)/Non-Access Stratum (NAS) reflective Quality of Service (QoS) and to ensure in-sequence packet delivery during remapping in 5G communication systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives a downlink data packet and determines a service data flow associated with the downlink data packet. The UE extracts, from the downlink data packet, a Non-Access Stratum (NAS) Reflective QoS Indication (RQI) indicator that instructs the UE to map a service data flow to the QoS flow. The UE also extracts, from the downlink data packet, a Quality of Service (QoS) flow identifier identifying a QoS flow. The UE generates a first NAS mapping that maps the service data flow to the QoS flow, in response to a determination that the service data flow is not mapped to the QoS flow at the UE. The UE further transmits, in accordance with the first NAS mapping, an uplink data packet associated with the service data flow through the QoS flow.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 illustrates a protocol stack for QoS flow-based 5G communication systems.

FIGS. 9A and 9B illustrate mappings of QoS flows for both downlink and uplink IP data flows.

FIG. 10 illustrates NAS level mappings of IP flows to QoS flows and AS level mappings of QoS flows to data bearers.

FIG. 11 is a sequence diagram illustrating NAS reflective QoS functionality.

FIG. 12 is a sequence diagram illustrating AS reflective QoS functionality.

FIG. 13 is a diagram showing an example of a SDAP header that may be utilized to enable NAS/AS reflective QoS functionality.

FIGS. 14A-B are diagrams illustrating utilization and processing of an example

SDAP header to enable reflective QoS flow mappings.

FIGS. 15A-B, 16 and 17 are diagrams illustrating utilization of an example SDAP header to guarantee in-sequence delivery of packets during QoS flow relocations.

FIGS. 18A-B are diagrams showing examples of SDAP headers that may be utilized to guarantee in-sequence delivery of packets during QoS flow relocations.

FIG. 19 is a flow chart 1900 of a method (process) for enabling NAS level mappings of IP flows to QoS flows.

FIG. 20 is a flow chart 2000 of a method (process) for enabling AS level mappings of QoS flows to data bearers.

FIG. 21A-B are flow charts 2100 and 2120, respectively, of a method (process) performed by a UE to guarantee in-sequence delivery of packets during QoS flow relocations.

FIG. 22A-C are flow charts 2200, 2220 and 2230, respectively, of a method (process) performed by a base station to guarantee in-sequence delivery of packets during QoS flow relocations.

FIG. 23 is a conceptual data flow diagram illustrating the data flow between different components/means in an exemplary apparatus.

FIG. 24 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

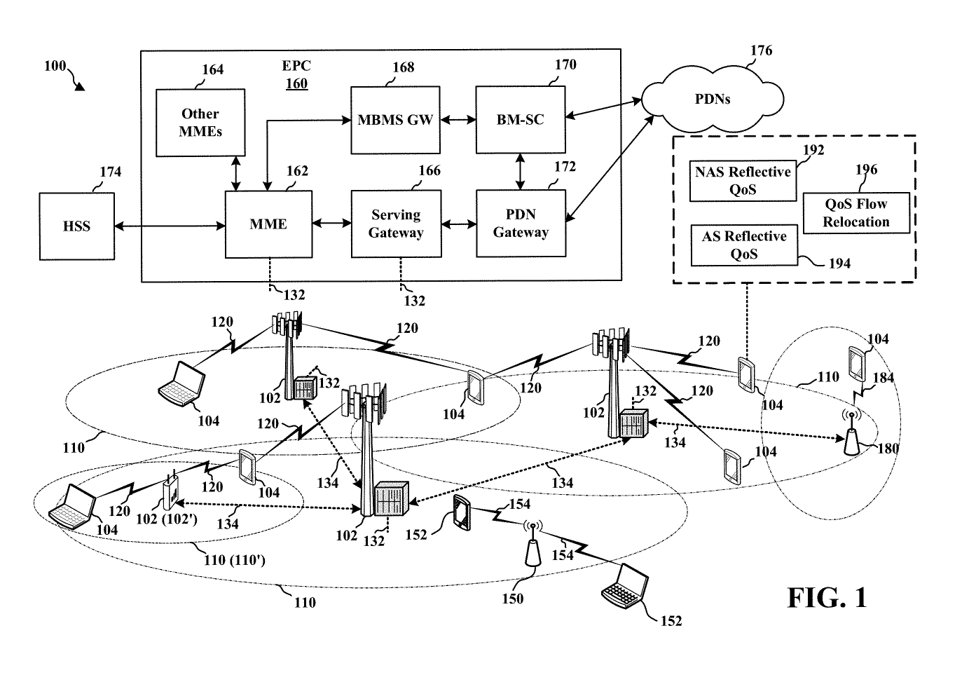

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 1 10. For example, the small cell 102′ may have a coverage area 110′ that overlaps the coverage area 1 10 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

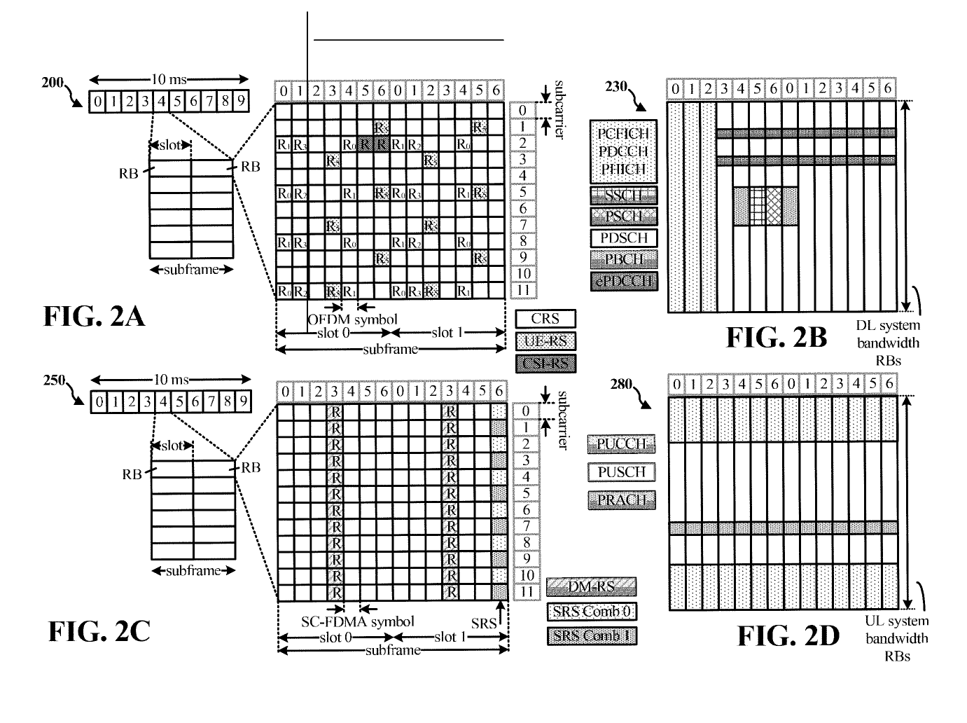

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

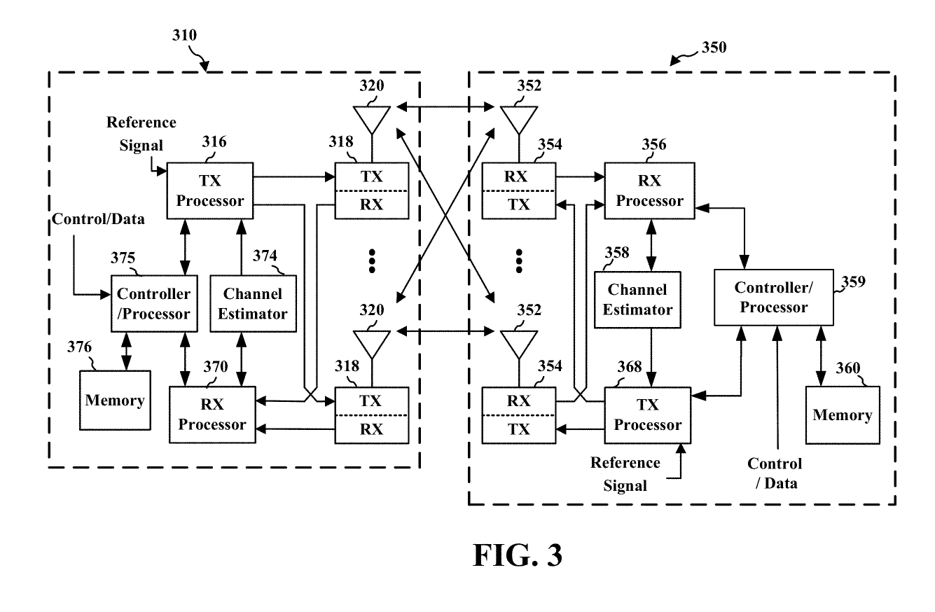

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

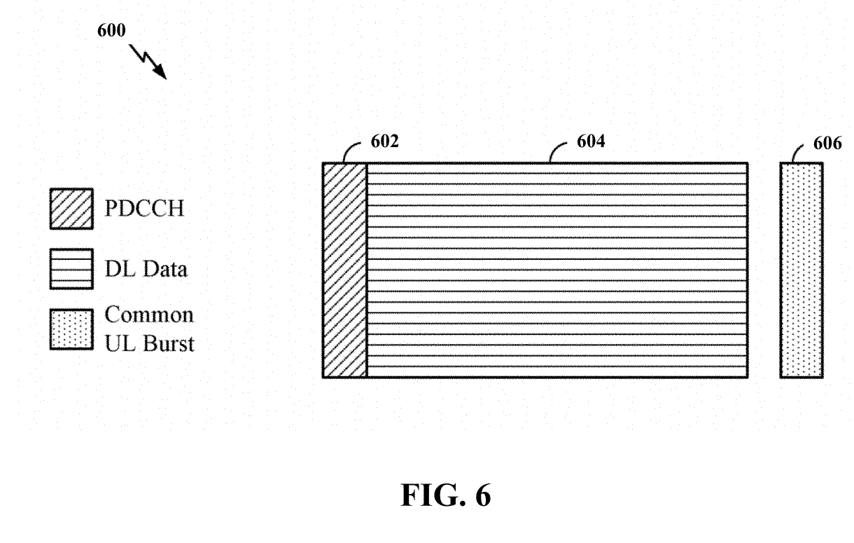

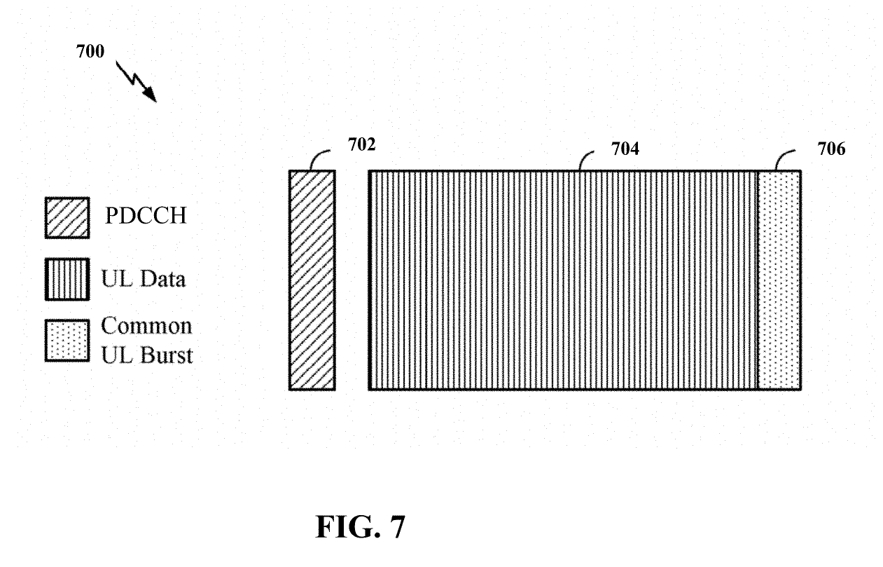

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

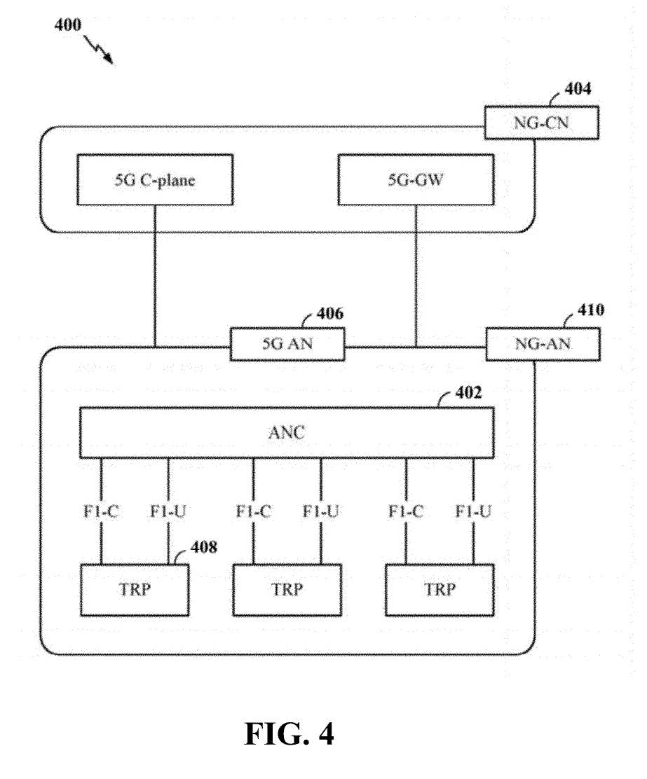

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The TRPs 408 may be a distributed unit (DU). The TRPs may be connected to one ANC (ANC 402) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

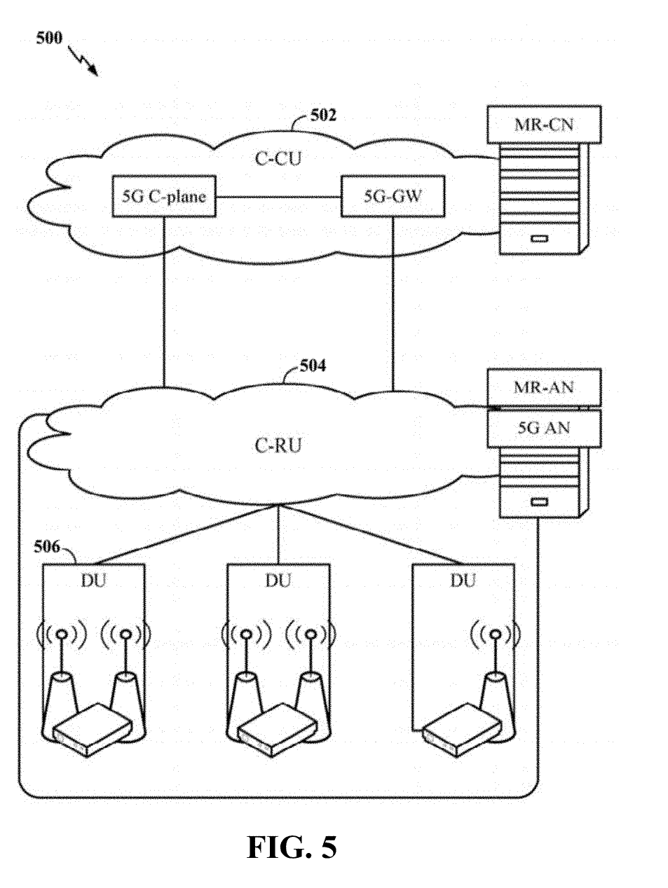

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Embodiments are disclosed below of a quality of service (QoS) model that supports a QoS flow based framework. Networks use QoS parameters to ensure that certain traffic types are handled in a certain way to provide a certain, threshold amount of QoS. For example, a given traffic flow may be classified by certain, generally static QoS parameters, such as guaranteed bit rate (GBR), non-guaranteed bit rate (non-GBR), priority handling, packet delay budget, packet error loss rate, and/or other parameters. When a traffic flow has a certain QoS parameter, it may for example be forwarded via a radio bearer that can carry traffic according to the QoS parameter.

In certain configurations, the EPS bearer handles all the user packets mapped to the EPS bearer with the same QoS. Within the EPS bearer, there is no further differentiated handling of the user plane packets. For improvement, the packets mapped to the different QoS flows belonging to the UE traffic can be handled differently. For example, multiple EPS bearers with different QoS parameters need to be created.

A QoS Flow ID (QFI) may be used to identify a QoS flow in the present disclosure. UP traffic with the same QFI within a PDU session receives the same traffic forwarding treatment (e.g. scheduling, admission threshold). It can be applied to PDUs with different types of payload, i.e. IP packets, non-IP PDUs and Ethernet frames. The QFI should be unique within a PDU session.

Each QoS flow (GBR and Non-GBR) may be associated with QoS parameters, such as a 5G QoS Indicator (5QI). A 5QI is a scalar that is used as a reference to 5G QoS characteristics, i.e., to access node-specific parameters that control QoS forwarding treatment for the QoS flow (e.g., scheduling weights, admission thresholds, queue management thresholds, link layer protocol configuration, etc.). QoS flows provide finest granularity for QoS differentiation of packets within a PDU session.

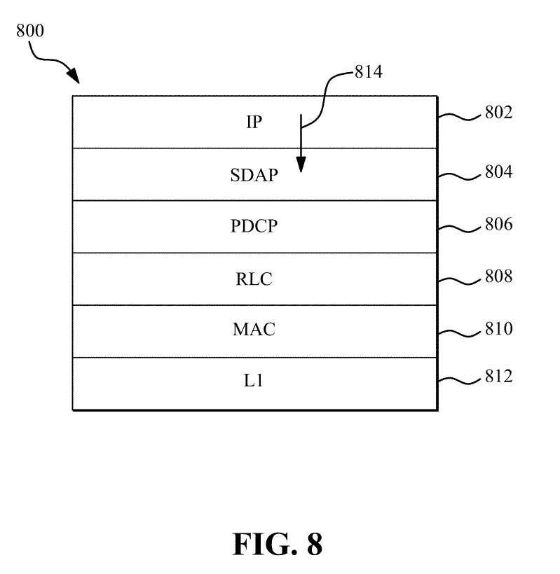

FIG. 8 illustrates a protocol stack for QoS flow-based communication systems.

The protocol stack shown in FIG. 8 includes a plurality of layers: an IP layer 802, SDAP layer 804, PDCP layer 806, RLC layer 808, MAC layer 810 and L1 layer 812.

The IP layer 802 is the network layer of the IP protocol suite, and provides a common packet format and addressing scheme capable of transporting data over multiple subnetwork technologies (e.g., Ethernet, ATM, and the like). Functionality of the PDCP layer 806, the RLC layer 808 and the MAC layer 810 is described above in conjunction with FIG. 3. The L1 layer 812 is a physical layer.

As noted above, on the radio interface, the present system has retained the DRB concept for user plane handling. This requires that the one or more QoS flows belonging to the PDU session of the UE is mapped to the DRB depending on the QoS requirement. The mapping of the QoS flow to the DRB is done within the new user plane protocol layer called Service Data Adaptation Protocol (SDAP) layer 804 which is placed above the PDCP layer 806 and below the IP layer 802. The SDAP entities are located in the SDAP layer 804. Several SDAP entities may be defined for a UE. There is the SDAP entity configured per cell group for each individual PDU session. The SDAP entity in the SDAP layer 804 performs mapping between the QoS flow and the data radio bearer for both the DL and the UL traffic.

QFI is used to identify the QoS flow. User plane traffic with the same session PDU QFI receives the same traffic transmission process (e.g., scheduling, and approval threshold (admission threshold)). QFI may be applied to each of the different types of payload PDU 814 (i.e., IP packets, unstructured packets, Ethernet frames, etc.).

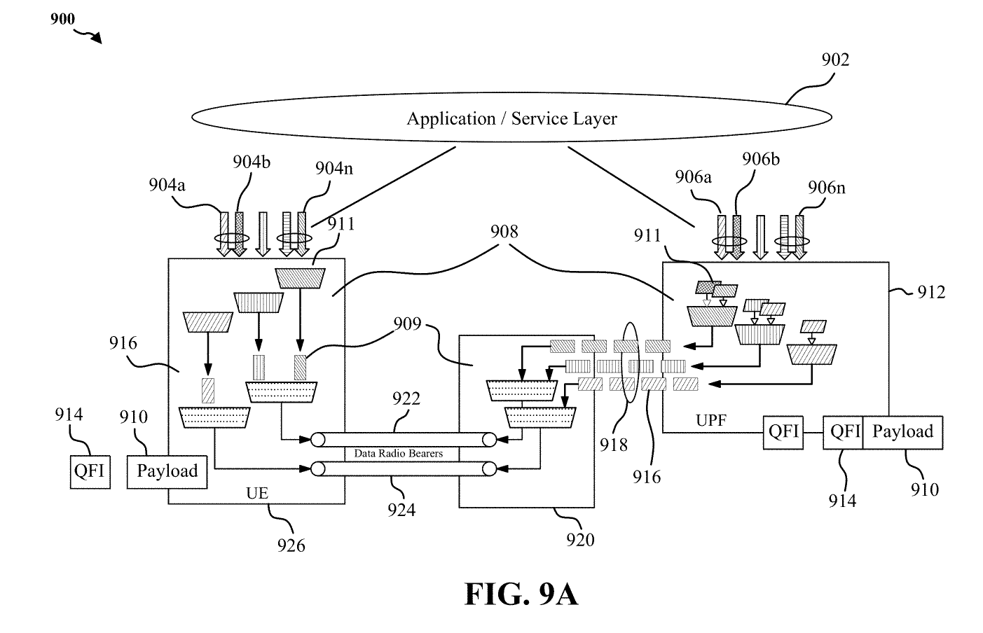

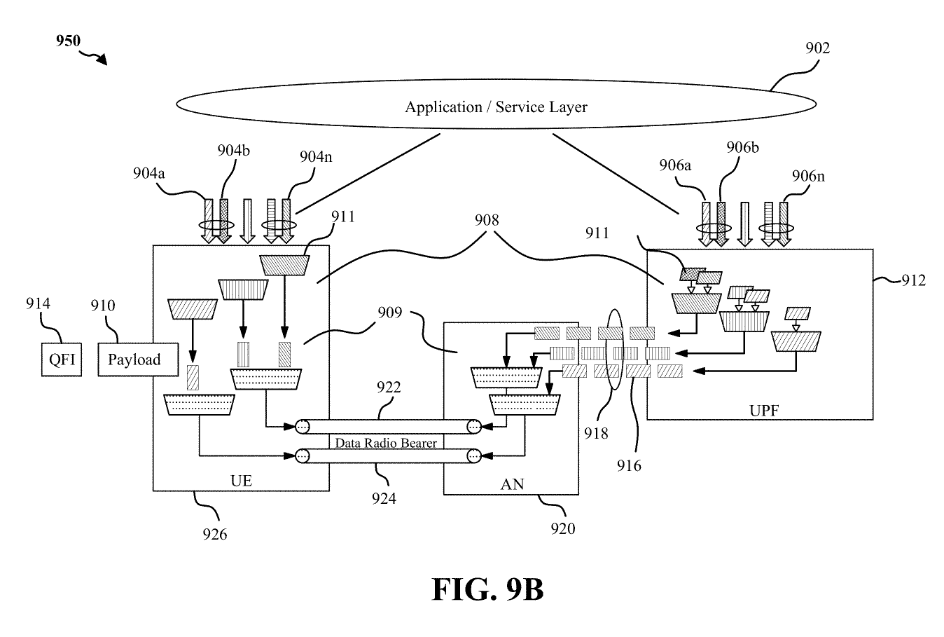

FIG. 9A illustrates mappings of QoS flows for downlink IP data flows. More specifically, FIG. 9A illustrates communication between User Plane Function (UPF) device/entity/function 912 and the UE 926. The UPF 912 may perform the same functions as the base station for modifying the QoS treatment of packets based on a request from the device; however the UPF 912 may not change the scheduling priority over the radio, but instead may change the QoS packet marking to match the modified QoS treatment when forwarding the packets to the base station (which causes the base station to modify the scheduling priority). Further, the UPF 912 is able to map one or more IP flows 906a-906n from an application or service layer 902 to one or more QoS flows. For example, IP packets sourced from the same application or service may be considered as being associated with the same IP flow. Similarly, IP packets destined to the same application or service may be considered as being associated with the same IP flow.

As shown in FIG. 9A, both the UPF 912 and the UE 926 also define packet filters 911 that allow the NAS level 908 at the UE 926 and the UPF 912 to decide which IP flow to map onto which QoS flow 916. This filtering may be performed based on source and destination IP address and port number. It is therefore flexible so that the network can map packets of different kinds of applications to different QoS flows 916.

Further, once the UPF 912 performs the classification and marking of the downlink user plane packets included in the IP flows 906a-906n to different QoS flows 916, the UPF 912 assigns a QFI 914 and adds it to a header of each payload packet 910 for every QoS flow 916 and transmits all QoS flows 916 of one or more PDU sessions 918 to a base station 920. For each PDU session, a single tunnel may be established between the UPF 912 and the base station 920 for exchanging the packets associated with different QoS flows 916 of the PDU session 918.

The base station 920 is configured to receive a plurality of packets of at least one QoS flow 916 from the UPF 912. The QFI 914 associated with the at least one QoS flow 916 is received in the header of each payload packet. Further, the base station 920 is configured to map each received packet of each QoS flow 916 to one of the DRBs 922, 924. The QoS flows 916 are mapped to the DRBs 922, 924 based on the QFI 914 associated with the QoS flows 916 according to certain rules described below. This mapping of QoS flows 916 to DRBs 922, 924 is performed at an AS level 909.

The QoS parameters of the QoS flow are also provided to the base station 920 as the QoS profile when the PDU session 918 is established or the new QoS flow 916 is established or when the radio connection is established. The QoS parameters may also be pre-configured in the base station 920. In the base station 920, the DRB 922,924 defines the packet treatment on the radio interface (i.e., Uu). The DRB 922, 924 serves the packets with the same packet forwarding treatment. Separate DRBs 922, 924 may be established for the QoS flows 916 requiring different packet forwarding treatment. The base station 920 knows the mapping between each QoS flow 916 and associated QoS parameters (or QoS profile) and accordingly decides the radio configuration for corresponding data radio bearer 922, 924. In the downlink, the base station 920 maps the QoS flows 916 to the DRBs 922, 924 based on the packet marking (i.e. QFI 914) and the associated QoS profiles. One DRB, such as a first DRB 922, can be mapped to multiple QoS flows. For each DRB 922, 924 configured, the base station 920 provides the list of one or more QFIs 914 and PDU session 918 identifier. The QoS parameters (e.g. packet error rate, latency, data rate, etc.) which are related to the radio level QoS can be same for multiple QoS flows and hence multiple QoS flows of same PDU session 918 can be mapped to same DRB (e.g., first DRB 922). The QoS flow 916 of the PDU session 918 is not mapped to more than one DRB 922, 924. The QoS flow of one PDU session and another QoS flow of another PDU session may have same QFI 914 but these are mapped to different DRBs 922, 924. In some configurations, QFI 914 is carried in an SDAP header, as described below.

FIG. 9B illustrates mappings of QoS flows for uplink IP data flows. In case of uplink traffic, the UE 926 maps the QoS flows 916 to the DRBs 922, 924 based on mapping received from the base station 920. Further, the UE 926 receives uplink user plane packets included in IP flows 904a-904n from a higher layer, such as Application/Service layer 902. Further, the UE 926 maps each packet first to a corresponding QoS flow 916 at the NAS level using corresponding packet filters 911. Next, the UE 926 maps each QoS flow 916 to corresponding DRBs 922, 924 based on the received QFI 914 at the AS level 909. It should be noted that if the incoming UL packet does not match a QoS Flow ID to DRB mapping (neither a configured nor a determined via reflective QoS), the UE 926 maps the packet to the default DRB (not shown in FIG. 9) of the PDU session. Further, the UE 926 also adds the QFI 914 in a header (e.g., SDAP header) of the packet sent on each DRB, including the default DRB. Further, the UE 926 transmits all uplink packets along with corresponding packet headers to the base station 920 via corresponding DRBs 922, 924 associated with particular QoS flows 916.

As noted above, each QoS flow 916 (GBR and Non-GBR) may be associated with QoS parameters using a special indicator, such as 5QI. The 5QI is a scalar that is used as a reference to 5G QoS characteristics. Each 5QI represents one combination of 5G QoS characteristics (certain QoS parameters, e.g., the scheduling weight, approval thresholds, queue management thresholds, etc.). In some configurations, 5QI may represent the following 5G QoS characteristics: resource type (GBR or Non-GBR), flow priority level, packet delay budget and packet error rate. Flow priority level is a parameter indicating the relative priority of fulfilling the required bit rate and delivery characteristics (packet delay budget, packet error rate). It impacts the PDU flow admission to resources in the network as well as the distribution of resources for packet forwarding treatment, allowing consistency in admission and resource distribution to fulfil the service requirements.

A Packet Delay Budget (PDB) is a QoS characteristic that describes one aspect of a packet forwarding treatment that a QoS flow receives edge-to-edge between the UE 926 and the UPF 912. The PDB defines an upper bound for the time that a packet may be delayed between the UE 926 and the UPF 912. For a certain 5QI the value of the PDB is the same in the UL and DL. In the case of 3GPP access, the PDB is used to support the configuration of scheduling and link layer functions (e.g. the setting of scheduling priority weights and HARQ target operating points). In other words, the PDB denotes an end-to-end “soft upper bound”.

It should be noted that some packets may dropped if the queuing time is longer the PDB or if the packet buffer is full. It is understood that PDUs may be stored in a packet buffer if a data rate, such as the short-term bit rate, is higher than the maximum bit rate associate with the PDU data flow. If packets are dropped, the number of dropped packets may be recorded. The long-term overall packet drop rate (or packet loss rate) may be limited to the packet error rate requirement.

There are two types of 5QI scalars in the communication systems of the present disclosure—standardized and non-standardized. Non-standardized 5QIs may be used by mobile network operators to associate different QoS characteristics with standardized 5QI type according to their own needs. QoS profile of the standardized 5QI is typically better for internetworking with EPC-based networks. It should be noted that UE's 926 behavior typically does not depend on a type of used 5QI scalars.

The one-to-one mapping of standardized 5QI values to QoS characteristics is specified in Table 1 below.

TABLE 1

| | | | Packet | | |
|---|---|---|---|---|---|
| 5QI, | Resource | Priority | Delay | Packet | |
| QFI | Type | Level | Budget | ErrorRate | Example Services |
| 1 | GBR | 20 | 100 ms | 10⁻² | Conversational Voice |
| 2 | | 40 | 150 ms | 10⁻³ | Conversational Video (Live Streaming) |
| 3 | | 30 | 50 ms | 10⁻³ | Real Time Gaming, V2X messages |
| 4 | | 50 | 300 ms | 10⁻⁶ | Non-Conversational Video (Buffered Streaming) |
| 65 | | 7 | 75 ms | 10⁻² | Mission Critical user plane Push To Talk voice (e.g., MCPTT) |
| 66 | | 20 | 100 ms | 10⁻² | Non-Mission-Critical user plane Push To Talk voice |
| 75 | | 25 | 50 ms | 10⁻² | V2X messages |
| 5 | Non- | 10 | 100 ms | 10⁻⁶ | IMS Signalling |
| 6 | GBR | 60 | 300 ms | 10⁻⁶ | Video (Buffered Streaming) |
| | | | | | TCP-based (e.g., www, e-mail, chat, ftp, p2p file sharing, |
| | | | | | progressive video, etc.) |
| 7 | | 70 | 100 ms | 10⁻³ | Voice, |
| | | | | | Video (Live Streaming) |
| | | | | | Interactive Gaming |
| 8 | | 80 | 300 ms | 10⁻⁶ | Video (Buffered Streaming) |
| | | | | | TCP-based (e.g., www, e-mail, chat, ftp, p2p file |
| 9 | | 90 | | | sharing, progressive video, etc.) |
| 69 | | 5 | 60 ms | 10⁻⁶ | Mission Critical delay sensitive signaling (e.g., MC-PTT |
| | | | | | signaling) |
| 70 | | 55 | 200 ms | 10⁻⁶ | Mission Critical Data (e.g. example services are the same as |
| | | | | | QCI 6/8/9) |
| 79 | | 65 | 50 ms | 10⁻² | V2X messages |

In the present disclosure, there are two options to control QoS flows using QFI. A first option is to use non-GBR QoS flows in combination with the standardized 5QI values. In this configuration, standardized 5QI is used as QFI. Further, in this configuration, when the traffic for that QoS flow starts, it does not require additional signaling over any interfaces (e.g., interface N2). A second option applies to both non-GBR and GBR QoS flows, where 5QI values are not used. In this configuration, the UE 926 needs to signal (transmit) QFI 914 to the base station 920 and to the UPF 912 over N2 and N7 interfaces, respectively. Further, in this configuration, when a QoS flow is established or when a PDU session for that QoS flow is established, additional signaling of QoS parameters is required.

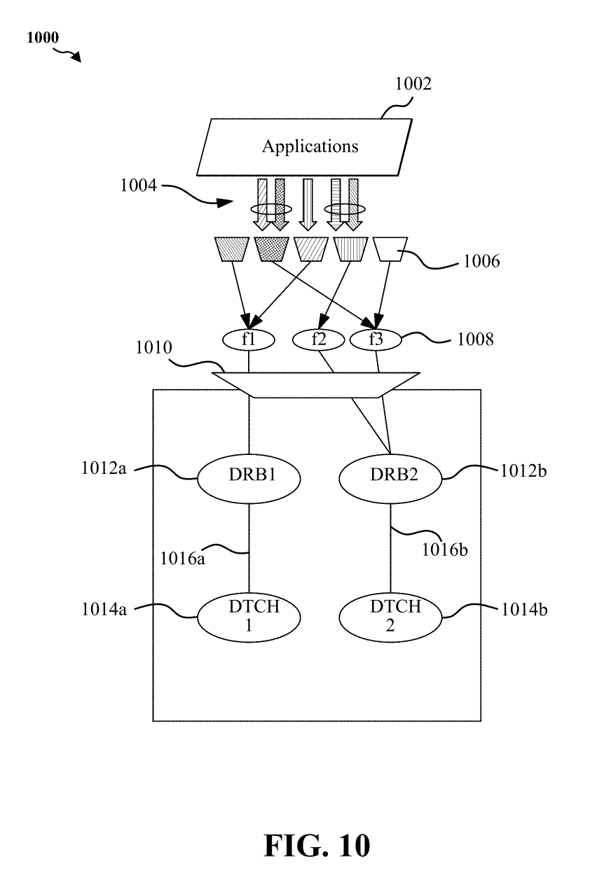

FIG. 10 illustrates NAS level mappings of IP flows to QoS flows and AS level mappings of QoS flows to data bearers based on corresponding mapping tables, which may be performed by an apparatus 1000. The apparatus 1000 may be either a UE (e.g. UE 926) or a base station (e.g., base station 920). As shown, in FIG. 10, the apparatus 1000 receives a plurality of packets belonging to one or more IP flows, which in turn belong to one or more PDU sessions (e.g., a first PDU session 1004). At NAS level, the apparatus 1000 performs the classification and marking of DL/UL traffic, i.e. the association of IP flows to QoS flows 1008, based on packet filters 1006 and based on QoS rules. These rules may be explicitly signaled over a N1 interface (at PDU session establishment or QoS flow establishment), pre-configured in the UE or implicitly derived by the UE from reflective QoS. A QoS rule may include a QoS rule identifier, the QFI of the QoS flow, and a QoS flow template (i.e. the set of packet filters 1006 and corresponding precedence values associated with the QoS flow 1008). One QoS flow can have one or more QoS rules.

The exemplary NAS level mappings of IP flows to QoS flows using QoS rules are specified in Table 2 below:

TABLE 2

| QoS rule ID | Precedence | Packet Filter | QFI |
|---|---|---|---|
| 1 | 1 | (UE IP, *, RTP, *, UDP) | 5 |
| 2 | 0 | (UE IP, *, 73, 73, *) | 65 |
| 3 | 2 | (UE IP, *, Game *, *) | 103 |
| 4 | 5 | | 9 |

In telecommunication systems of the present disclosure, each PDU session 1004 is required to have a default QoS rule. In table 2 above, the last QoS rule having QoS rule Id equal to 4 is the default QoS rule. The default QoS rule is the only QoS rule associated with a particular PDU session that may contain no packet filter (as shown in Table 2).

Upon completing the mappings between IP flows and QoS flows 1008, at AS level 1010, the apparatus 1000 performs the association of QoS flows 1008 to DRBs 1012, based on corresponding mapping table. The exemplary AS level mappings of QoS flows 1008 to DRBs 1012 are specified in Table 3 below:

TABLE 3

| QFI | Data Radio Bearer ID |
|---|---|
| 1 | drb1 |
| 2 | drb2 |
| 5 | drb2 |
| Others | drb3 |

Last row of Table 3 indicates that all unknown QFIs will be mapped to a default third DRB (not shown in FIG. 10).

As shown in FIG. 10, each of a first DRB 1012a and second a DRB 1012b sends corresponding QoS flow packets to the corresponding dedicated logical traffic channel 1014a and 1014b with encryption and Robust Header Compression (ROHC) 1016a and 1016b, respectively.

As noted above, embodiments of the present invention support utilization of SDAP headers for handling AS/NAS reflective QoS functionality. NAS reflective QoS is an optional feature used in the communication systems of the present disclosure to control UE derived QoS rules by downlink traffic implicitly. More specifically, network decides which QoS rules to apply on DL traffic, and UE reflects the DL QoS rules to the associated UL traffic. When UE receives a DL packet for which reflective QoS should be applied, the UE creates a new derived QoS rule, if needed. The packet filter in the derived QoS rule is derived from the DL packet. It is possible to apply both reflective QoS and non-reflective QoS on the same PDU session. Further, AS reflective QoS is an optional feature used by base stations in the communication systems of the present disclosure to configure QoS flow to DRB mapping by downlink traffic implicitly.

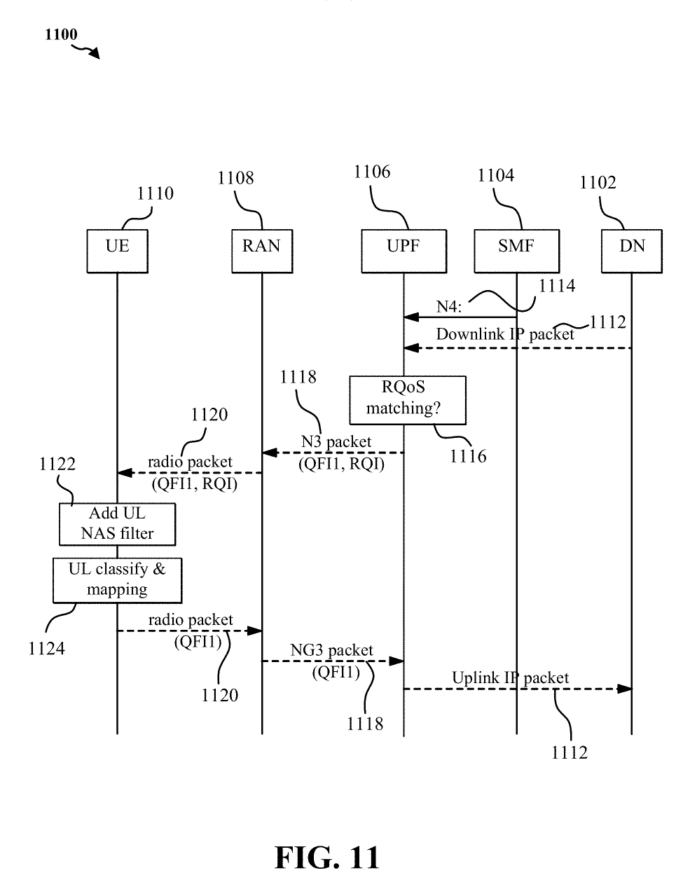

FIG. 11 is a sequence diagram illustrating NAS reflective QoS functionality. In some configurations, the communications system 1100 comprises a Data Network (DN) 1102 (e.g., operator services, Internet access or 3rd party services), Session Management Function (SMF) 1104, UPF 1106, base station 1108, and UE 1110. As shown in FIG. 11, packets of the PDU session in the DL direction traverse from the DN 1102 to the UPF 1106 over a N6 interface 1112, from the UPF 1106 to the base station 1108 over a N3 interface 1118 and from the base station 1108 to the UE 1110 over a radio interface 1120.

In the present disclosure, the SMF 1104 is configured to control: session management (e.g., by session establishment, modifications and release), UE IP address allocation and management, routing traffic from the UPF 1106 with the appropriate destination steering (traffic steering) setting, policy control enforcement, and QoS interface, among other functionalities. The SMF 1104 communicates with the UPF 1106 over a N4 interface 1114. In this configuration, when the network determines to activate reflective NAS QoS, the SMF 1104 sends a reflective QoS rule associated with the downlink packet sent over the N6 interface 1112 to the UPF 1106. The reflective QoS rule is sent by the SMF 1104 via N4 interface 1114. The reflective QoS rule indicates to the UPF 1106 that NAS reflective QoS should be activated. When the UPF 1106 receives a DL packet matching the QoS rule that contains an indication to activate reflective QoS, the UPF 1106 includes a Reflective QoS Indicator (RQI) along with the QFI of the QoS flow in the header of the packet transmitted over the N3 interface 1118. Of note, the base station 1108 also adds a header (e.g., SDAP header) to a DL radio packet transmitted over the radio interface 1120.

In some configurations, when the UE 1110 receives the DL packet for which reflective QoS should be applied (packet having a set RQI indicator within the header), the UE 1110 creates a new derived QoS rule. The packet filter in the derived QoS rule is derived from the received DL packet. The UE 1110 also adds 1122 the derived packet filter to the plurality of NAS level packet filters 1006. At operation 1124, the UE 1110 performs the classification and marking of UL traffic using the newly created NAS level packet filter and using the derived QoS rule. The RQI is sent for downlink user plane traffic only.

As shown in FIG. 11, packets of the PDU session in the uplink (UL) direction traverses from the UE 1110 to the base station 1108 over the radio interface 1120, from the base station 1108 to the UPF 1106 over the N3 interface 1118 and from the UPF 1106 to the DN 1102 over the N6 interface 1112. It should be noted that the RQI is sent for downlink user plane traffic only, but the uplink traffic traversing from the UE 1110 to the UPF 1106 carries the QFI of the corresponding QoS flow in AS protocol (i.e., SDAP) header.

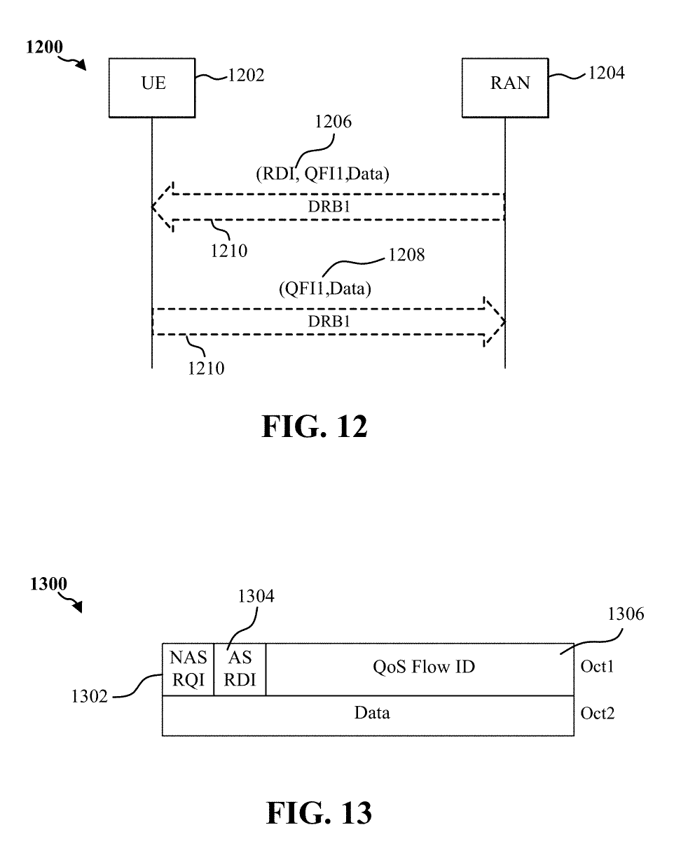

FIG. 12 is a sequence diagram 1200 illustrating AS reflective QoS functionality. In various configurations, the base station 1204 configures QoS flow to DRB mapping using one of two mechanisms. In one configuration, the UE 1202 receives mapping of the QoS flow identifiers to the DRBs for each established PDU session from the base station 1204 in a signaling message (e.g., RRC signaling message). In another configuration, the AS reflective QoS functionality may be activated implicitly through the DL packet using Reflective QoS flow to DRB mapping Indication (RDI). As shown in FIG. 12, the RDI is sent for downlink user plane traffic only and is contained within the AS protocol header 1206 along with the QFI of the downlink packet transmitted via a particular DRB 1210. The RDI bit indicates whether QoS flow to DRB mapping rule should be updated. Based on the received RDI bit, the UE 1202 selectively updates corresponding QoS flow to DRB mapping rule and sends the UP packets 1208 associated with the same QoS flow using the same DRB 1210.

FIG. 13 is a diagram showing an example of a SDAP header that may be utilized to enable NAS/AS reflective QoS functionality. It should be noted that in some configurations the SDAP header 1300 may not be present and may be configured per DRB. If configured, size of the SDAP header 1300 for a DRB is static (e.g., 1 byte). Presence of the SDAP header 1300 in DL traffic and UL traffic can be separately configured through corresponding RRC signaling procedures.

As shown in FIG. 13, in some configurations, the SDAP header 1300 may include two additional indicators along with the QFI 1306. The RQI indicator 1302 is utilized to configure NAS reflective QoS by indicating an update of NAS level mapping rule(s). The RDI indicator 1304 is used to configure AS reflective QoS by indicating whether AS level mapping rule (QoS flow to DRB mapping rule) should be updated. In some configurations, both the RDI 1302 and the RDI 1304 are one bit long. As shown in FIGS. 11 and 12 the RQI 1302 and the RDI 1304 may be sent separately depending on a utilized base station policy.

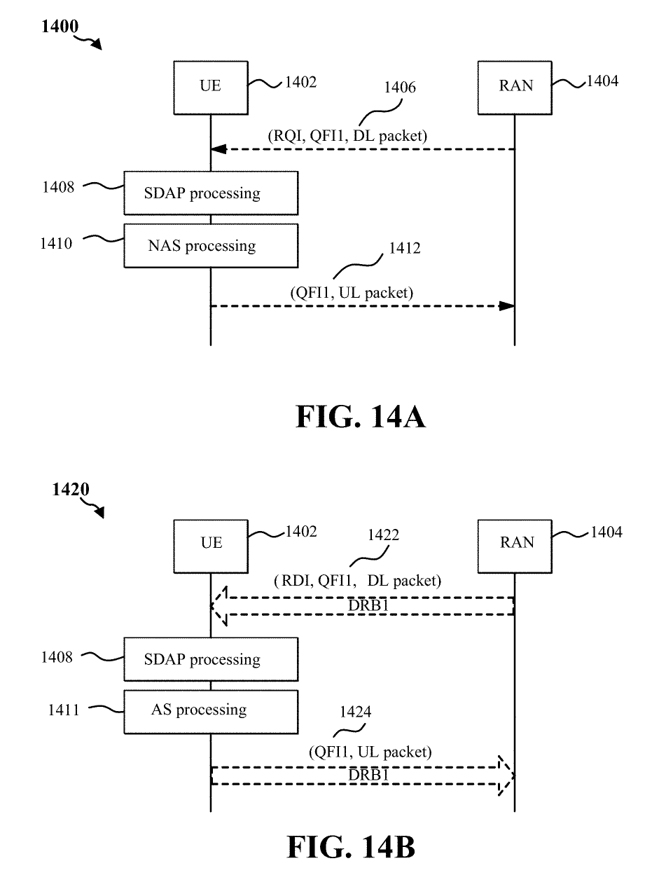

FIG. 14A is a diagram illustrating utilization and processing of an example SDAP header to enable NAS reflective QoS flow mappings. As shown in FIG. 14A, the DL packet transmitted from the base station 1404 to the UE 1402 may include the SDAP header 1406 (if configured to be present). The SDAP header 1406 includes the RQI and QFI indicators. At operation 1408, the UE 1402 performs SDAP header processing. In one configuration, SDAP header processing 1408 involves extracting both the RQI and QFI from the header. In another configuration, the UE 1402 extracts the RQI indicator first, determines whether the RQI indicator is set to 1 and extracts the QFI from the header only in response to determining that the RQI indicator is set. Further, if the RQI is set, the UE 1402 informs the upper (NAS) layer of the RQI and QFI. For the UL packets, the SDAP processing operation 1408 involves adding the identical QFI (received from the NAS level) to the SDAP header 1412 of the UL packet if the SDAP header 1412 is configured to be present for the UL traffic.

Next, at operation 1410, the UE 1402 performs NAS processing to enable NAS reflective QoS if configured. More specifically, at operation 1410, the UE 1402 extracts the packet filter from the DL packet. In some configurations, the UE 1402 derives the NAS level packet filter from a corresponding IP header of the DL packet. The IP header includes a 5-tuple consisting of source IP address, destination IP address, source port number, destination port number, and network protocol ID. The operation 1410 also involves performing a reflective processing on the derived NAS level packet filter for the UL traffic. In some configurations, this reflective processing comprises reversing source and destination IP addresses and port numbers for the NAS level packet filter for a corresponding UL traffic. In other words, the reflective processing involves creating a mirror packet header and mirror the QoS in a different flow direction (UL). The UE 1402 also determines whether there is an existing QoS rule (NAS level mapping) that maps the IP flow of the received DL packet to a corresponding QoS flow. If such NAS level mapping does not exist, the UE 1402 adds the newly derived QoS rule to the current NAS level mappings table and potentially removes the old QoS rule, if needed. In addition to creating a NAS level packet filter for the UL traffic, operation 1410 involves sending the QFI to the SDAP layer.

FIG. 14B is a diagram illustrating utilization and processing of an example SDAP header to enable AS reflective QoS flow mappings. As shown in FIG. 14B, the SDAP header 1422 (if configured to be present) includes the RDI and QFI indicators. At operation 1408, the UE 1402 performs SDAP header processing. In one configuration, SDAP header processing 1408 involves extracting both the RDI and QFI from the header. In another configuration, the UE 1402 extracts the RDI indicator first, determines whether the RDI indicator is set to 1 and extracts the QFI from the header only in response to determining that the RDI indicator is set. Further, if the RDI is set, the UE 1402 informs the AS level of the RDI and QFI. For the UL packets, the SDAP processing operation 1408 involves adding the identical QFI (received from the AS level) to the SDAP header 1424 of the UL packet if the SDAP header 1424 is configured to be present for the UL traffic.

Next, at operation 1411, the UE 1402 performs AS processing to enable AS reflective QoS if configured. More specifically, at operation 1411, the UE 1402 determines the identifier of the DRB over which the DL packet was received. The UE 1402 also determines whether there is an existing AS level mapping (QoS flow to DRB mapping) that maps the QoS flow of the received DL packet to the identified DRB. If such AS level mapping does not exist, the UE 1402 adds the newly derived QoS flow to DRB mapping to the current AS level mappings table and potentially removes the old mapping, if needed. In some configurations, the AS processing 1411 for the UL packet involves identifying the QoS flow associated with the QFI to determine which DRB should be used to send the UL packet.

In some configurations, SDAP headers may also be utilized to address in-sequence delivery of packets (e.g. PDCP PDUs) during QoS flow relocation also known as QoS flow to DRB remapping. QoS flow to DRB remapping is defined as the operation that changes the mapping relation between a QoS flow and a DRB, i.e., a QoS flow is reconfigured to be carried on a different DRB. The remapping may take place when the base station wants to move a QoS flow in the default DRB to a dedicated DRB. Moreover, the present DRB for a QoS flow may become unavailable due to the change of radio environment including Handover (HO). And the base station may adjust DRB allocation to better cope with the current traffic mix.

QoS flow relocation also means that data is moved from a first PDCP entity (source PDCP entity) to a second PDCP entity (target PDCP entity). This means that PDCP sequence numbers can no longer be used as a mechanism for guaranteeing in-sequence delivery of PDUs during QoS flow relocation/remapping, as there is currently no mechanism to guarantee delivery order across different PDCP entities yet.

During QoS flow to DRB remapping, it is possible that one QoS flow is remapped to a more suitable DRB, which means that the latency of the target DRB may be shorter than that of the source DRB. In this case, a packet sent over the target DRB may arrive earlier than a previous one sent over the source DRB. Therefore it is possible at the receiving side that one QoS flow is carried on more than one DRB at the same time.

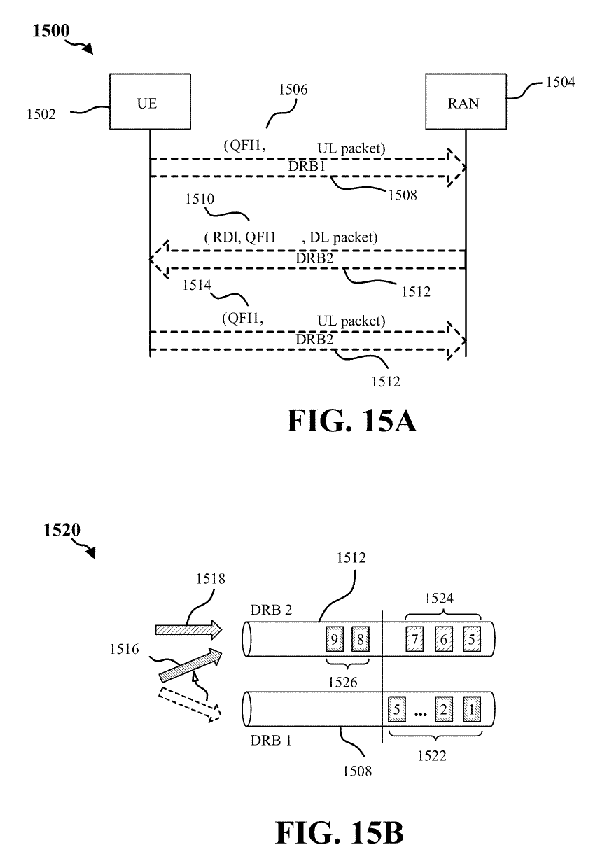

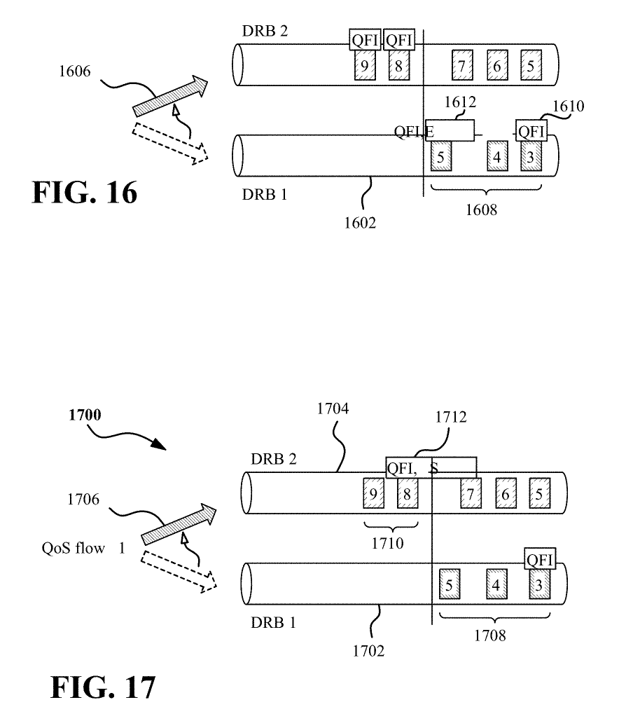

Referring to the diagram 1500 of FIG. 15A now, assume that the UE 1502 originally send UL packets associated with a particular QoS flow to the base station 1504 through the first DRB 1508. At some point, the base station 1504 decides to relocate this QoS flow to the second DRB 1512. The UE 1502 finds out about the remapping when it receives a DL packet having SDAP header 1510 through the second DRB 1512. As shown in FIG. 15A, the SDAP header 1510 includes both the QFI associated with the relocated QoS flow and the RDI indicator discussed above. In response, the UE 1502 starts sending UL packets with the corresponding SDAP header 1514 through the second DRB 1512.

FIG. 15B is a diagram 1520 illustrating additional details related to QoS flow relocation. More specifically, packets 1522 represent UL packets associated with the first QoS flow 1516 that were sent by the UE 1502 through the first DRB 1508. Packets 1524 represent UL packets associated with the second QoS flow 1518 that were sent by the UE 1502 through the second DRB 1512. Further, packets 1526 represent UL packets associated with the first QoS flow 1516 that were sent by the UE 1502 through the second DRB 1512 after the QoS flow relocation.

Embodiments of the present invention address the aforementioned problem by adding a special marker to the SDAP header. FIG. 16 illustrates one solution to in-sequence packet delivery problem during QoS flow relocation. More specifically, the UE 1502 (not shown in FIG. 16) adds a one bit indicator in the SDAP header of a corresponding UL packet when changing transmit PDCP entity. Packets 1608 represent packets sent by the UE through the first DRB 1602 prior to relocation of the QoS flow 1606. SDAP headers 1610 of the first two packets 1608 include only the QFI indicator. However, before transmitting through the first DRB 1602 the last UL packet associated with the QoS flow 1606, the UE 1502 adds a special so called “end-marker” to the header 1612 of that last packet. After the QoS flow relocation takes place, the UE 1502 starts sending UL packets through the second DRB 1604. It should be noted that the SDAP headers 1614 of these UL packets no longer include any special markers (e.g., end markers).

Upon receiving the packet having the end-marker (e.g., packet having SDAP header 1612), the SDAP receiver on the other side of the DRB (e.g., SDAP receiver of the base station 1504) knows that the transmission of the QoS flow 1606 is going to end in this first DRB 1602. If the SDAP receiver of the base station 1504 subsequently receives packets of the same QoS flow 1606 in the second DRB 1604, the SDAP receiver of the base station 1504 knows that all packets were received in a proper order and can seamlessly pass all received UL packets to upper layers. However, if the SDAP receiver of the base station 1504 receives packets of the same flow in the second DRB 1604 without receiving a packet with the SDAP header having an end marker in the first DRB 1602, the SDAP receiver of the base station 1504 knows that out-of-order delivery has occurred and holds the new packet(s) until the packet containing an end marker in the header is received. In other words, if packets having headers 1614 of the QoS flow 1606 arrive in the second DRB 1604 prior to the arrival of the packet having header 1612 in the first DRB 1602, the SDAP receiver of the base station 1504 holds the packets having headers 1614 having the same QFI in a special buffer until the arrival of packet having headers 1612, so that all packets can be delivered in order to upper layers on the base station side.

FIG. 17 illustrates alternative solution to in-sequence packet delivery problem during QoS flow relocation. More specifically, the UE 1502 (not shown in FIG. 17) adds a one bit indicator in the SDAP header of a corresponding UL packet when changing transmit PDCP entity. Packets 1708 represent packets sent by the UE through the first DRB 1702 prior to relocation of the QoS flow 1706. SDAP headers of the first UL packets 1708 include only the QFI indicator. If after the QoS flow relocation takes place there are no additional packets to be transmitted through the first DRB 1702 to which a special end-marker can be added or if the first DRB 1702 gets released, in one configuration, the SDAP transmitter of the UE 1502 adds a special, so called start-marker to the header 1712 of the first UL packet transmitted through the second DRB 1704 to indicate the start of transmission of the QoS flow 1706 through the second DRB 1704. In this case, upon receiving the packet 1710 containing the start-marker within its header by the SDAP receiver side (e.g., the SDAP receiver of the base station 1504), the SDAP layer of the base station 1504 can directly pass all received packets 1708, 1710 to upper layers without waiting, since it knows that all packets were received in proper order.

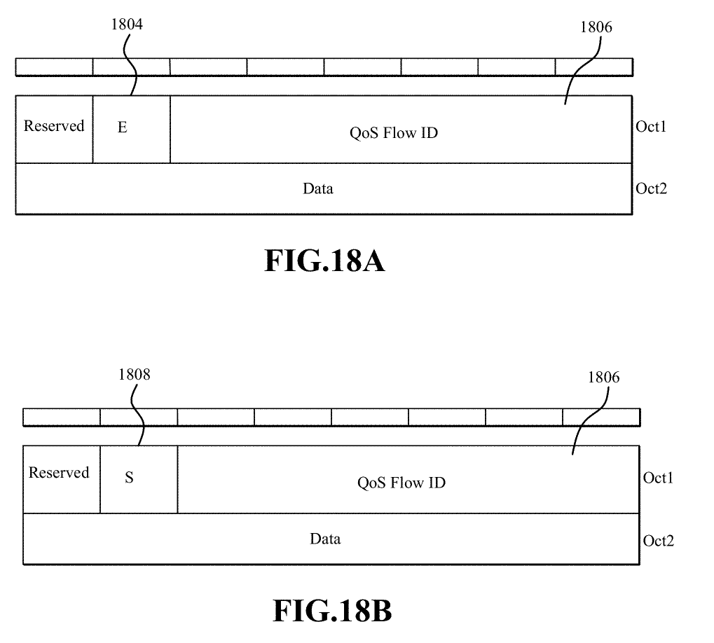

FIGS. 18A and 18B are diagrams showing examples of SDAP headers 1800 that may be utilized to guarantee in-sequence delivery of packets during QoS flow relocations. In one configuration, either an end-marker 1804 or a start-marker 1808 described below can be represented by a single bit along with the QFI 1806 within the SDAP header 1800 during QoS flow relocation/remapping procedure. In other words, the SDAP transmitter of the UE always uses either the end-marker 1804 or the start-marker 1808 depending on if there are any additional packet transmissions pending through the original DRB (e.g., the first DRB 1702 in FIG. 17). In one configuration, the SDAP transmitter of the UE may use acknowledgments sent by the RLC layer to determine whether any particular packet was successfully sent. In one configuration, if all transmitted packets are successfully acknowledged or if the SDAP transmitter no longer has any additional packets to send or if the original DRB is released, the SDAP transmitter of the UE can use the start-marker 1808 to shorten the latency, otherwise the end-marker 1804 is used. On the receiver side (e.g., base station side) the SDAP receiver waits for either the end-marker 1804 from the first DRB or waits for the start-marker 1808 from the second DRB. It should be noted that this functionality works the same in both directions. In other words, the SDAP transmitter of the UE is capable of adding start-markers 1808/end-markers 1804 to the corresponding UL packets, while the SDAP receiver of the UE is capable of properly interpreting these markers.

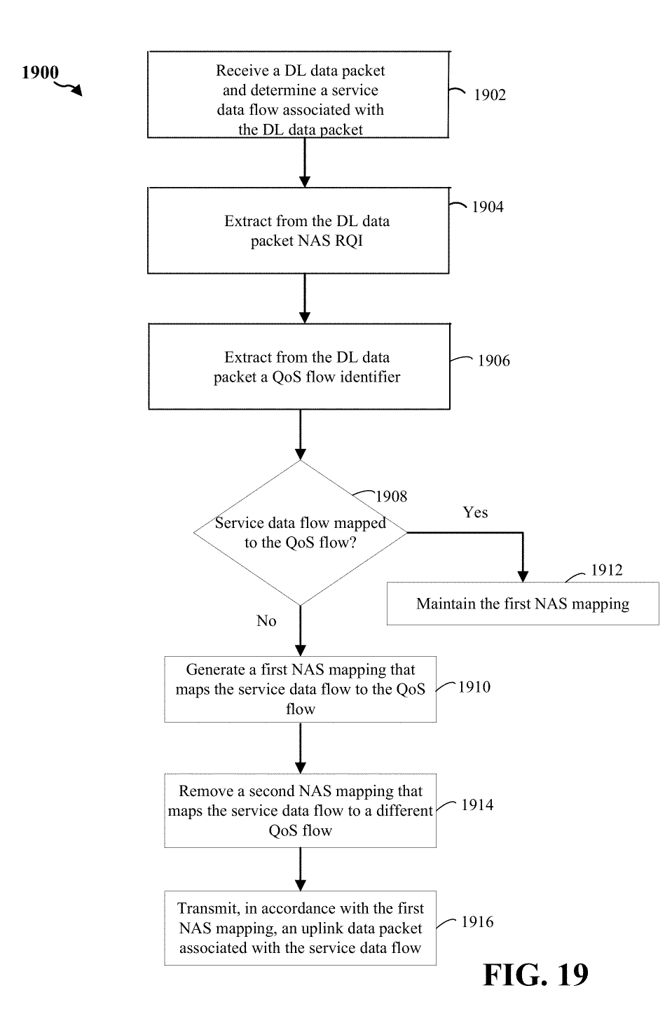

FIG. 19 is a flow chart 1900 of a method (process) for enabling NAS reflective QoS functionality. The method may be performed by a UE (e.g., the NAS reflective QoS component 192 of thr UE 104, the UE 350, the UE 1110, the UE 1402, the apparatus 2302/2302′). At operation 1902, the UE receives a DL data packet and determines a service data flow associated with the DL data packet. At operation 1904, the UE extracts from the DL data packet a NAS RQI indicator that instructs the UE to map the service protocol flow to the QoS flow. At operation 1906, the UE extracts from the DL data packet a QFI identifying a QoS flow associated with the received DL data packet.

At operation 1908, the UE determines whether the service data flow is mapped to the QoS flow at the UE. At operation 1910, the UE generates a new NAS mapping that maps the service data flow to the QoS flow, in response to a determination that the service data flow is not mapped to the QoS flow at the UE. At operation 1912, the UE maintains an old NAS mapping, in response to a determination that the service data flow is mapped to the QoS flow at the UE.

At operation 1914, the UE removes an old NAS mapping that maps the service data flow to a different QoS flow, in response to a determination that the service data flow is not mapped to the QoS flow at the UE. At operation 1916, the UE transmits, in accordance with the new NAS mapping, an UL data packet associated with the service data flow through the QoS flow.

In some configurations, the NAS RQI indicator is extracted from a SDAP header of the DL data packet.

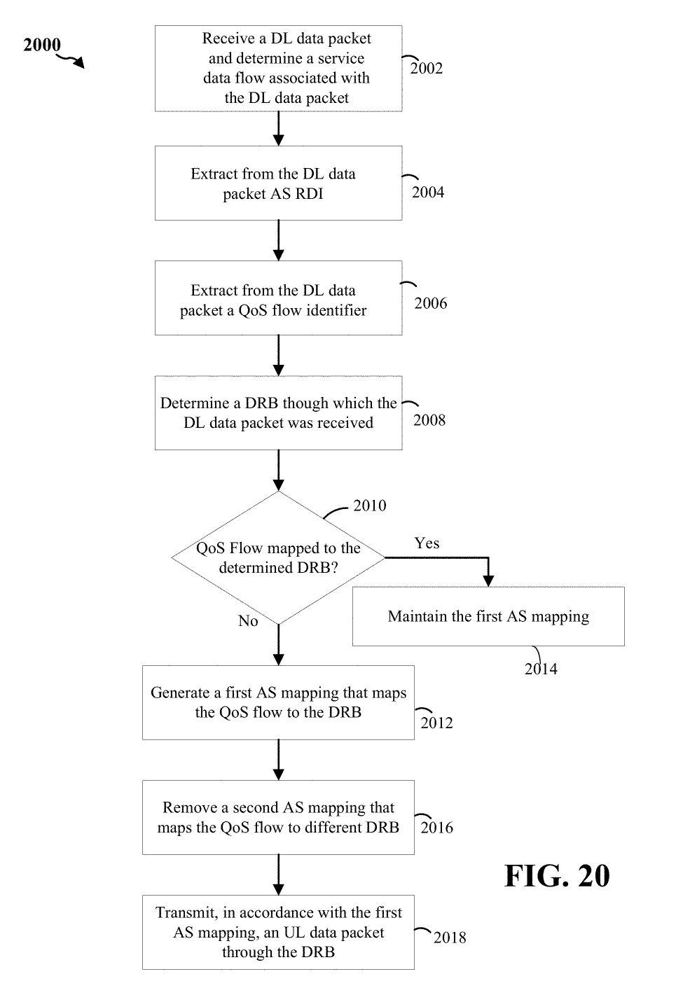

FIG. 20 is a flow chart 2000 of a method (process) for enabling AS reflective QoS functionality. The method may be performed by a UE (e.g., the AS reflective QoS component 194 of the UE 104, the UE 350, the UE 1110, the UE 1402, the apparatus 2302/2302′). At operation 2002, the UE receives a DL data packet and determines a service data flow associated with the DL data packet. At operation 2004, the UE extracts from the DL data packet an AS RDI indicator that instructs the UE to map the QoS flow to the DRB. At operation 2006, the UE extracts from the DL data packet a QFI identifying a QoS flow associated with the received DL data packet. At operation, 2008, the UE determines a DRB through which the DL data packet was received.

At operation 2010, the UE determines whether the QoS flow is mapped to the determined DRB at the UE. At operation 2012, the UE generates a new AS mapping that maps the QoS flow to the DRB, in response to a determination that the QoS flow is not mapped to the DRB at the UE. At operation 2014, the UE maintains an old AS mapping, in response to a determination that the QoS flow is mapped to the DRB at the UE.

At operation 2016, the UE removes an old AS mapping that maps the QoS flow to a different DRB, in response to a determination that the QoS flow is not mapped to the DRB at the UE. At operation 2018, the UE transmits, in accordance with the new AS mapping, an UL data packet associated with the service data flow through the DRB.

In some configurations, the AS RDI indicator is extracted from a SDAP header of the DL data packet.

In some configurations, the QFI indicator is extracted from the SDAP header of the DL data packet.

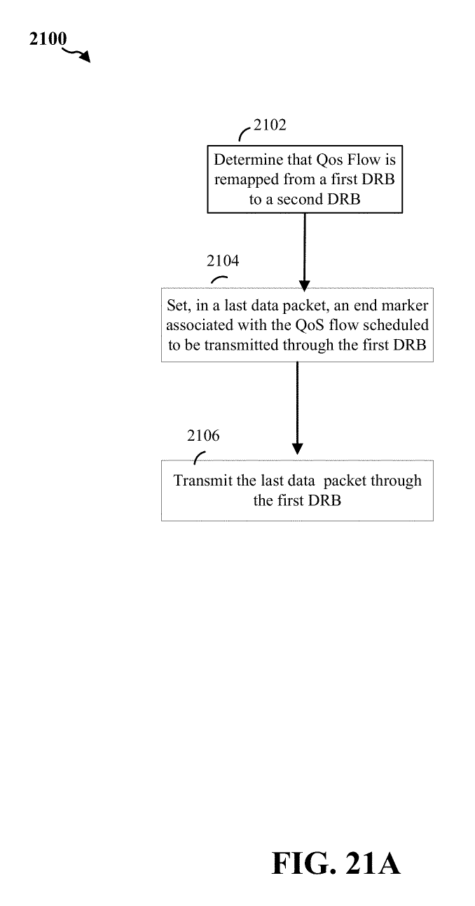

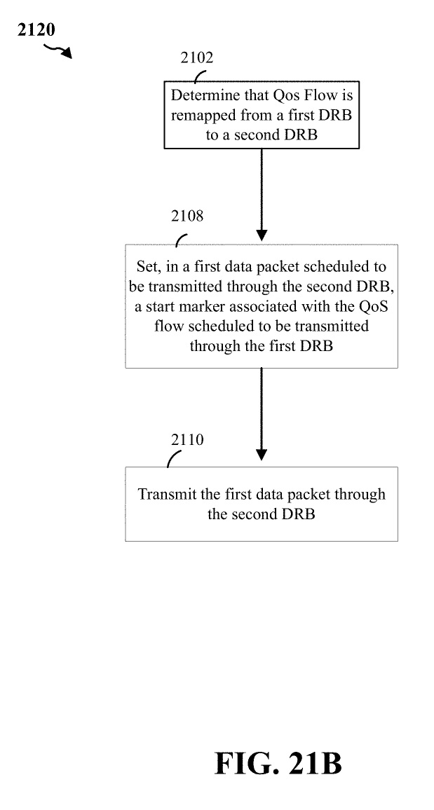

FIG. 21A-B are flow charts 2100 and 2120, respectively, of a method (process) performed by a QoS Flow Relocation component 196 of the UE 104, the UE 350, the UE 1110, the UE 1402, the apparatus 2302/2302′ to guarantee in-sequence delivery of packets during QoS flow relocations.

The method may be performed by a UE (e.g., the UE 104, the UE 350, the UE 1110, the UE 1402, the apparatus 2302/2302′). Starting with the flow chart 2100 of FIG. 21A, at operation 2102, the UE determines whether a QoS flow is remapped from a first DRB to a second DRB. At operation 2104, the UE sets, in a last data packet of the one or more data packets, an end marker indicating an end of packets associated with the QoS flow scheduled to be transmitted through the first DRB, in response to a determination that the one or more data packets remain to be transmitted through the first DRB. At operation, 2106, the UE transmits the last data packet through the first DRB.

Referring now to the flow chart 2120 of FIG. 21B, at operation 2102, the UE determines whether a QoS flow is remapped from a first DRB to a second DRB. At operation 2108, the UE sets a start marker indicating a start of packets associated with the QoS flow scheduled to be transmitted through the second DRB in a first data packet associated with the QoS flow scheduled to be transmitted through the second DRB, in response to a determination that no more data packets associated with the QoS flow remain to be transmitted through the first DRB, or if the first DRB was released. At operation 2110, the UE transmits the first data packet through the second DRB.

In some configurations, the end marker is included in the SDAP header of the last data packet.

In some configurations, the start marker is included in the SDAP header of the last data packet.

In some configurations, the determination whether the QoS flow is remapped is made by receiving the QFI and AS RDI in the DL packets and by detecting that the DRB associated with the QoS flow has changed.

In some configurations, the determination whether the QoS flow is remapped is made by receiving a RRC message of Radio Bearer Configuration and by detecting that the DRB mapping provided in the RRC message is different from previous DRB mapping.

In some configurations, the UE receives a RRC message indicating the configuration of a radio bearer, the UE determines whether the QoS flow associated with the QoS flow associated with the DRB requires in-sequence delivery. The UE enables end marker mechanism if in-sequence delivery is required and disables the end marker mechanism otherwise.

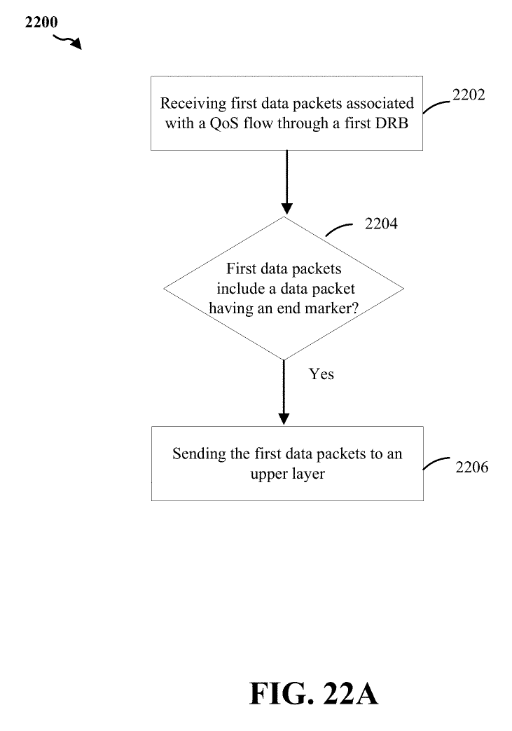

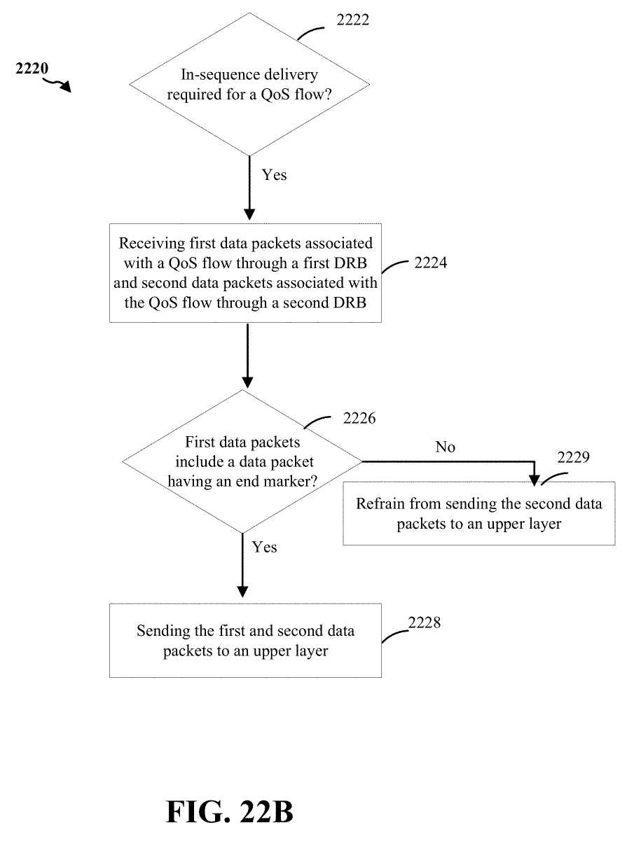

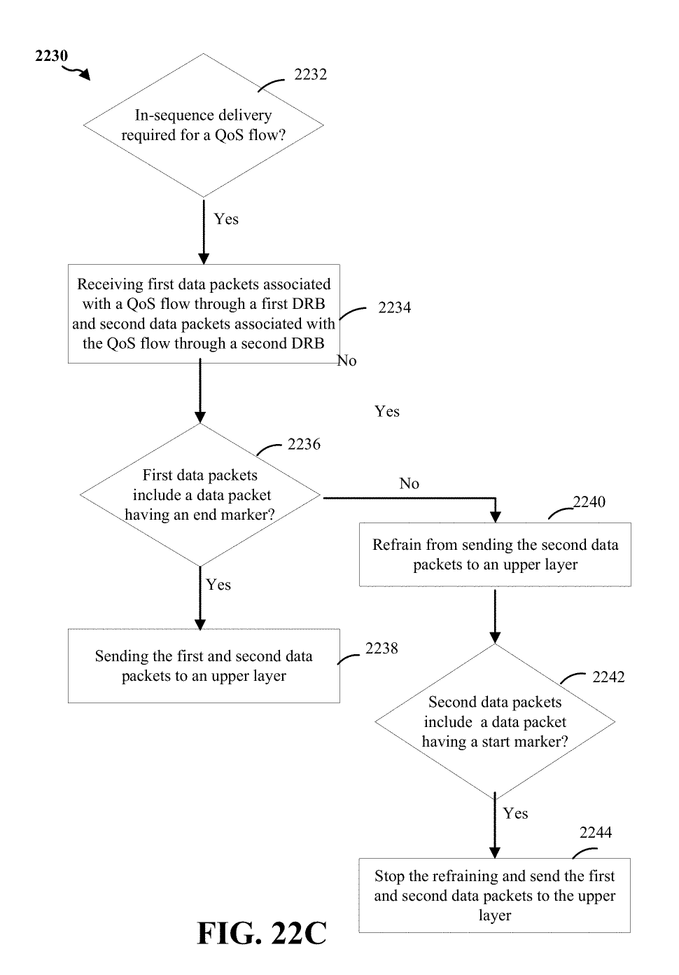

FIGS. 22A-C are flow charts 2200, 2220 and 2230, respectively of a method (process) performed by a base station to guarantee in-sequence delivery of packets during QoS flow relocations. The method may be performed by a base station (e.g., base station 102, base station 310, etc.).

Starting with FIG. 22A, in certain configurations, at operation 2202, the base station receives a first one or more data packets associated with a QoS flow through a first DRB. At operation 2204, the base station determines whether at least one of the first one or more data packets includes a data packet having an end marker indicating an end of packets associated with the QoS flow scheduled to be transmitted through the first DRB. At operation 2206, the base station sends the first one or more data packets to an upper layer.

Referring now to FIG. 22B, in certain configurations, at operation 2222, the base station determines whether in-sequence delivery is required for a QoS flow. At operation 2224, the base station receives a first one or more data packets associated with a QoS flow through a first DRB and receives a second one or more data packets associated with the QoS flow through a second DRB. At operation 2226, the base station determines whether at least one of the first one or more data packets includes a data packet having an end marker indicating an end of packets associated with the QoS flow scheduled to be transmitted through the first DRB. At operation 2228, the base station sends the second one or more data packets to an upper layer subsequent to the first one or more data packets being sent to the upper layer, in response to a determination that at least one of the first one or more data packets includes the data packet having the end marker. At operation, 2229, the base station refrains from sending the second one or more data packets to the upper layer, in response to a determination that none of the first one or more data packets includes the data packet having the end marker.

Referring now to FIG. 22C, in certain configurations, at operation 2232, the base station determines whether in-sequence delivery is required for a QoS flow. At operation 2234, the base station receives a first one or more data packets associated with a QoS flow through a first DRB and receives a second one or more data packets associated with the QoS flow through a second DRB. At operation 2236, the base station determines whether at least one of the first one or more data packets includes a data packet having an end marker indicating an end of packets associated with the QoS flow scheduled to be transmitted through the first DRB. At operation 2238, the base station sends the second one or more data packets to an upper layer subsequent to the first one or more data packets being sent to the upper layer, in response to a determination that at least one of the first one or more data packets includes the data packet having the end marker. At operation, 2240, the base station refrains from sending the second one or more data packets to the upper layer, in response to a determination that none of the first one or more data packets includes the data packet having the end marker.

At operation 2242, the base station determines whether at least one of the second one or more data packets includes a data packet having a start marker indicating a start of packets associated with the QoS flow scheduled to be transmitted through the second DRB, in response to a determination that none of the first one or more data packets includes the data packet having the end marker. At operation 2244, the base station stops the refraining and sends the second one or more data packets to the upper layer subsequent to the first one or more data packets being sent to the upper layer, in response to a determination that at least one of the second one or more data packets includes the data packet having the start marker.

In some configurations, the determination whether the at least one of the second one or more data packets includes a data packet having the start marker includes detecting the start marker in a SDAP header of the at least one of the second one or more data packets.

In some configurations, the determination whether the at least one of the first one or more data packets includes a data packet having the end marker includes detecting the end marker in the SDAP header of the at least one of the first one or more data packets

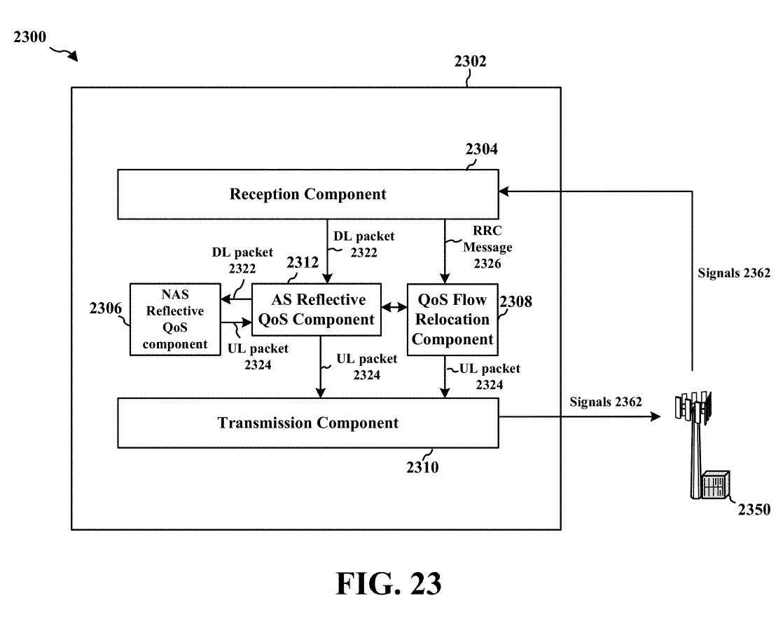

FIG. 23 is a conceptual data flow diagram 2300 illustrating the data flow between different components/means in an exemplary apparatus 2302. The apparatus 2302 may be either a UE. The apparatus 2302 includes a reception component 2304, a NAS Reflective QoS component 2306, an AS Reflective QoS component 2312, a QoS flow relocation component 2308 and a transmission component 2310. The reception component 2304 may receive signals 2362 from a base station 2350 and the transmission component 2310 may send signals 2364 to the base station 2350.

In certain configurations, the NAS reflective QoS component 2306 is pre-configured to enable NAS reflective QoS functionality. In other words, the NAS reflective QoS component 2306 is pre-configured to determine which QoS rules to apply on DL traffic, and configured to reflect the DL QoS rules to the associated UL traffic.

The NAS reflective QoS component 2306 receives a DL data packet 2322 and determines a service data flow associated with the DL data packet 2322. The DL data packet 2322 includes the QFI and may include a NAS RQI indicator. The NAS reflective QoS component 2306 extracts from the DL data packet 2322 a QFI and extracts a NAS RQI indicator (if present) that instructs the NAS reflective QoS component 2306 to map the service protocol flow to the QoS flow.

The NAS reflective QoS component 2306 determines whether the service data flow is mapped to the QoS flow. The NAS reflective QoS component 2306 generates a new NAS mapping that maps the service data flow to the QoS flow, in response to a determination that the service data flow is not mapped to the QoS flow at the UE. The NAS reflective QoS component 2306 maintains an old NAS mapping, in response to a determination that the service data flow is mapped to the QoS flow at the UE. The NAS reflective QoS component 2306 removes an old NAS mapping that maps the service data flow to a different QoS flow, in response to a determination that the service data flow is not mapped to the QoS flow at the UE. The NAS reflective QoS component 2306 sends to the transmission component 2310 an UL data packet 2324 associated with the QoS flow in accordance with the new NAS mapping. In other words, QoS rules of the UL data packet is identical to the QoS rules of the corresponding DL data packet 2322, if the DL data packet 2322 included a set NAS RQI indicator. The NAS RQI indicator may be included in a SDAP header of the DL data packet 2322.

In certain configurations, the AS Reflective QoS component 2312 is pre-configured to enable AS reflective QoS functionality. In other words, the AS Reflective QoS component 2312 is pre-configured to control QoS flow to DRB mapping by downlink traffic implicitly. The AS reflective QoS component 2312 receives a DL data packet 2322 and determines a service data flow associated with the DL data packet 2322. The AS Reflective QoS component 2312 extracts from the DL data packet 2322 a QFI and an AS RDI indicator (if present) that instructs the AS Reflective QoS component 2312 to map the QoS flow to the DRB. The AS Reflective QoS component 2312 determines a DRB through which the DL data packet 2322 was received.

The AS Reflective QoS component 2312 determines whether the QoS flow is mapped to the determined DRB at the UE. The AS Reflective QoS component 2312 generates a new AS mapping that maps the QoS flow to the DRB, in response to a determination that the QoS flow is not mapped to the DRB at the UE. The AS Reflective QoS component 2312 maintains an old AS mapping, in response to a determination that the QoS flow is mapped to the DRB at the UE.

The AS Reflective QoS component 2312 removes an old AS mapping that maps the QoS flow to a different DRB, in response to a determination that the QoS flow is not mapped to the DRB at the UE. The AS Reflective QoS component 2312 sends to the transmission component 2310 an UL data packet 2324 associated with the QoS flow in accordance with the new AS mapping. In other words, the AS Reflective QoS component 2312 indicates to the transmission component which DRB to use to transmit the UL data packet 2324, if the DL data packet 2322 included a set AS RDI indicator. In some configurations, the QFI and the AS RDI indicator are extracted from a SDAP header of the DL data packet 2322.

In certain configurations, the QoS Flow Relocation component 2308 is pre-configured to guarantee in-sequence delivery of packets during QoS flow relocations. The QoS Flow Relocation component 2308 determines whether a QoS flow is remapped from a first DRB to a second DRB. In some configurations, the AS Reflective QoS component 2312 indicates to the QoS Flow Relocation Component 2308 that QoS flow relocation occurred when the AS Reflective QoS component 2312 receives the QFI and AS RDI in the DL packets 2322 and when the AS Reflective QoS component 2312 detects that the DRB associated with the QoS flow has changed. In some configurations, the determination whether the QoS flow is remapped is made by the QoS Flow Relocation Component 2308 when it receives a RRC message 2326 and detects that the DRB mapping provided in the RRC message 2326 is different from previous DRB mapping.

The QoS Flow Relocation Component 2308 determines whether one or more UL data packets 2324 associated with the QoS flow remain to be transmitted through the first DRB, in response to a determination that the QoS flow is remapped from the first DRB to the second DRB. The QoS Flow Relocation Component 2308 sets, in a last data packet of the one or more UL data packets 2324, an end marker indicating an end of packets associated with the QoS flow scheduled to be transmitted through the first DRB, in response to a determination that the one or more data packets remain to be transmitted through the first DRB. The QoS Flow Relocation Component 2308 indicates to the transmission component 2310 to transmit the last UL data packet 2324 through the first DRB.

The QoS Flow Relocation Component 2308 sets a start marker indicating a start of packets associated with the QoS flow scheduled to be transmitted through the second DRB in a first data packet associated with the QoS flow scheduled to be transmitted through the second DRB, in response to a determination that no more data packets associated with the QoS flow remain to be transmitted through the first DRB, or if the first DRB was released. The QoS Flow Relocation Component 2308 indicates to the transmission component 2310 to transmit the first UL data packet 2324 through the second DRB. In some configurations, the end marker and the start marker are included in the SDAP header of the last/first data packet associated with corresponding DRBs.

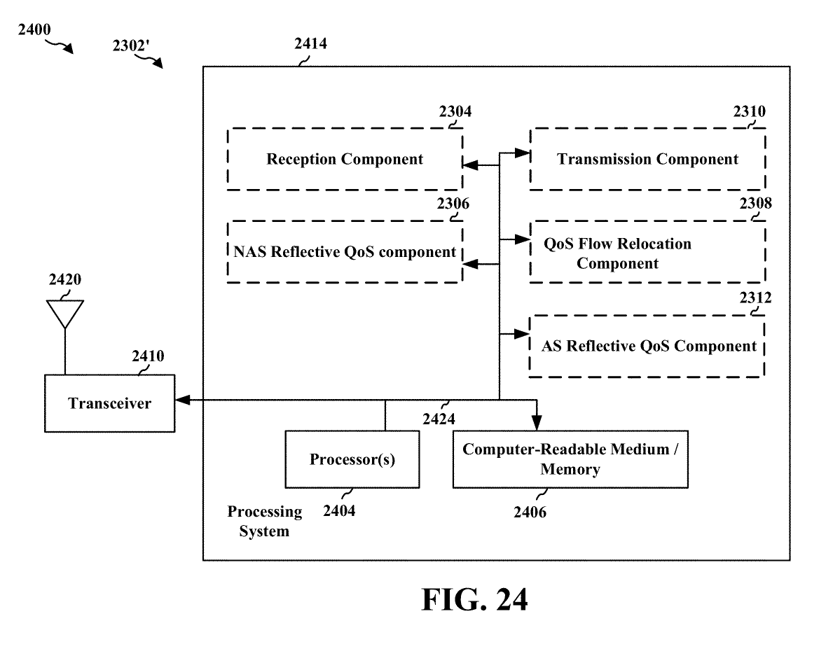

FIG. 24 is a diagram 2400 illustrating an example of a hardware implementation for an apparatus 2302′ employing a processing system 2414. The apparatus 2302′ may be a UE. The processing system 2414 may be implemented with a bus architecture, represented generally by a bus 2424. The bus 2424 may include any number of interconnecting buses and bridges depending on the specific application of the processing system 2414 and the overall design constraints. The bus 2424 links together various circuits including one or more processors and/or hardware components, represented by one or more processors 2404, the reception component 2304, the NAS Reflective QoS component 2306, the AS Reflective QoS component 2312, the QoS flow relocation component 2308, the transmission component 2310, and a computer-readable medium/memory 2406. The bus 2424 may also link various other circuits such as timing sources, peripherals, voltage regulators, and power management circuits, etc.

The processing system 2414 may be coupled to a transceiver 2410, which may be one or more of the transceivers 354. The transceiver 2410 is coupled to one or more antennas 2420, which may be the communication antennas 352.

The transceiver 2410 provides a means for communicating with various other apparatus over a transmission medium. The transceiver 2410 receives a signal from the one or more antennas 2420, extracts information from the received signal, and provides the extracted information to the processing system 2414, specifically the reception component 2304. In addition, the transceiver 2410 receives information from the processing system 2414, specifically the transmission component 2310, and based on the received information, generates a signal to be applied to the one or more antennas 2420.

The processing system 2414 includes one or more processors 2404 coupled to a computer-readable medium/memory 2406. The one or more processors 2404 are responsible for general processing, including the execution of software stored on the computer-readable medium/memory 2406. The software, when executed by the one or more processors 2404, causes the processing system 2414 to perform the various functions described supra for any particular apparatus. The computer-readable medium/memory 2406 may also be used for storing data that is manipulated by the one or more processors 2404 when executing software. The processing system 2414 further includes at least one of the reception component 2304, the NAS Reflective QoS component 2306, the AS Reflective QoS component 2312, the QoS flow relocation component 2308 and the transmission component 2310. The components may be software components running in the one or more processors 2404, resident/stored in the computer readable medium/memory 2406, one or more hardware components coupled to the one or more processors 2404, or some combination thereof. In one configuration, the processing system 2414 may be a component of the UE 350 and may include the memory 360 and/or at least one of the TX processor 368, the RX processor 356, and the communication processor 359.

In one configuration, the apparatus 2302/apparatus 2302′ for wireless communication includes means for performing each of the operations of FIGS. 19-22. The aforementioned means may be one or more of the aforementioned components of the apparatus 2302 and/or the processing system 2414 of the apparatus 2302′ configured to perform the functions recited by the aforementioned means.

As described supra, the processing system 2314 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means. It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE) comprising:
receiving a downlink data packet and determining a service data flow associated with the downlink data packet;
extracting, from the downlink data packet, a Non-Access Stratum (NAS) Reflective QoS Indication (RQI) indicator that instructs the UE to map a service data flow to the QoS flow;
extracting, from the downlink data packet, a Quality of Service (QoS) flow identifier identifying a QoS flow;
generating a first NAS mapping that maps the service data flow to the QoS flow, in response to a determination that the service data flow is not mapped to the QoS flow at the UE; and
transmitting, in accordance with the first NAS mapping, an uplink data packet associated with the service data flow through the QoS flow.

2. The method of claim 1, further comprising:
removing a second NAS mapping that maps the service data flow to a different QoS flow, in response to the determination that the service data flow is not mapped to the QoS flow at the UE.

3. The method of claim 1, further comprising:
maintaining the first NAS mapping, in response to a determination that the service data flow is mapped to the QoS flow at the UE.

4. The method of claim 1, wherein the RQI indicator is extracted from a Service Data Adaptation Protocol (SDAP) header of the downlink data packet.

5. An apparatus for a wireless communication comprising:
a processor and a memory device coupled to the processor, the memory device containing a set of instructions that, when executed by the processor, cause the processor to:
receive a downlink data packet and determine a service data flow associated with the downlink data packet;
extract, from the downlink data packet, a Non-Access Stratum (NAS) Reflective QoS Indication (RQI) indicator that instructs the UE to map a service data flow to the QoS flow;
extract, from the downlink data packet, a Quality of Service (QoS) flow identifier identifying a QoS flow;
generate a first NAS mapping that maps the service data flow to the QoS flow, in response to a determination that the service data flow is not mapped to the QoS flow at the UE; and
transmit, in accordance with the first NAS mapping, an uplink data packet associated with the service data flow through the QoS flow.

6. The apparatus of claim 5, wherein the set of instructions that, when executed by the processor, further cause the processor to remove a second NAS mapping that maps the service data flow to a different QoS flow, in response to the determination that the service data flow is not mapped to the QoS flow at the UE.

7. The apparatus of claim 5, wherein the set of instructions that, when executed by the processor, further cause the processor to maintain the first NAS mapping, in response to a determination that the service data flow is mapped to the QoS flow at the UE.

8. A method of wireless communication of a user equipment (UE) comprising:
receiving a downlink data packet and determining a service data flow associated with the downlink data packet;
extracting, from the downlink data packet, an Access Stratum (AS) Reflective QoS flow to Data Radio Bearer (DRB) mapping Indication (RDI) indicator that instructs the UE to map the QoS flow to the DRB;
extracting, from the downlink data packet, a Quality of Service (QoS) flow identifier (QFI) identifying a QoS flow;
determining a Data Radio Bearer (DRB) through which the downlink data packet is received;
generating a first AS mapping that maps the QoS flow to the DRB, in response to a determination that the QoS flow is not mapped to the DRB at the UE; and
transmitting, in accordance with the first AS mapping, the uplink data packet through the DRB.

9. The method of claim 8, further comprising:
removing a second AS mapping that maps the QoS flow to a different DRB, in response to the determination that the QoS flow is not mapped to the DRB at the UE.

10. The method of claim 8, further comprising:
maintaining the first AS mapping, in response to a determination that the QoS flow is mapped to the DRB at the UE.

11. The method of claim 8, wherein the RDI indicator is extracted from a Service Data Adaptation Protocol (SDAP) header of the downlink data packet.

12. The method of claim 8, wherein the QFI indicator is extracted from the SDAP header of the downlink data packet.

13. An apparatus for a wireless communication comprising:
a processor and a memory device coupled to the processor, the memory device containing a set of instructions that, when executed by the processor, cause the processor to:
receive a downlink data packet and determine a service data flow associated with the downlink data packet;
extract, from the downlink data packet, an Access Stratum (AS) Reflective QoS flow to Data Radio Bearer (DRB) mapping Indication (RDI) indicator that instructs the UE to map the QoS flow to the DRB;
extract, from the downlink data packet, a Quality of Service (QoS) flow identifier (QFI) identifying a QoS flow;
determine a Data Radio Bearer (DRB) through which the downlink data packet is received;
generate a first AS mapping that maps the QoS flow to the DRB, in response to a determination that the QoS flow is not mapped to the DRB at the UE; and
transmit, in accordance with the first AS mapping, the uplink data packet through the DRB.

14. The apparatus of claim 13, wherein the set of instructions that, when executed by the processor, further cause the processor to remove a second AS mapping that maps the QoS flow to a different DRB, in response to the determination that the QoS flow is not mapped to the DRB at the UE.

15. The apparatus of claim 13, wherein the set of instructions that, when executed by the processor, further cause the processor to maintaining the first AS mapping, in response to a determination that the QoS flow is mapped to the DRB at the UE.

16. The apparatus of claim 13, wherein the RDI indicator is extracted from a Service Data Adaptation Protocol (SDAP) header of the downlink data packet.

17. The apparatus of claim 13, wherein the QFI indicator is extracted from the SDAP header of the downlink data packet.

18. A method of wireless communication of a user equipment (UE), the method comprising:
determining whether a Quality of Service (QoS) flow is remapped from a first data radio bearer (DRB) to a second DRB;
setting, in a last data packet of the one or more packets, an end marker indicating an end of packets associated with the QoS flow scheduled to be transmitted through the first DRB, in response to determining that one or more data packets remain to be transmitted through the first DRB; and
transmitting the last data packet through the first DRB from the UE.

19. The method of claim 18, wherein the end marker is included in a Service Data Adaptation Protocol (SDAP) header of the last data packet.

20. The method of claim 18, further comprising:
setting a start marker indicating a start of packets associated with the QoS flow scheduled to be transmitted through the second DRB in a first data packet associated with the QoS flow scheduled to be transmitted through the second DRB, in response to determining that no more data packets associated with the QoS flow remain to be transmitted through the first DRB or the first DRB was released; and
transmitting the first data packet through the second DRB.

21. The method of claim 18, wherein determining a Quality of Service (QoS) flow is remapped by:
receiving the QoS flow Identifier and AS RDI in the downlink packets; and
detecting the DRB associated with the QoS flow has changed.

22. The method of claim 18, wherein determining a Quality of Service (QoS) flow is remapped by:
receiving a RRC message of Radio Bearer Configuration; and
detecting the DRB mapping provided in the RRC message is different from previous DRB mapping.

23. The method of claim 18, further comprising:
receiving a RRC message indicating the configuration of a radio bearer;
determining whether the QoS flows associated to the DRB requires in-sequence delivery;
enabling end-marker mechanisms if in-sequence delivery is required and disabling end-marker mechanism if in-sequence delivery is not required.

24. An apparatus for a wireless communication comprising:
a processor and a memory device coupled to the processor, the memory device containing a set of instructions that, when executed by the processor, cause the processor to:
determine whether a Quality of Service (QoS) flow is remapped from a first data radio bearer (DRB) to a second DRB;
set, in a last data packet of the one or more packets, an end marker indicating an end of packets associated with the QoS flow scheduled to be transmitted through the first DRB, in response to determining that one or more data packets remain to be transmitted through the first DRB; and
transmit the last data packet through the first DRB from the UE.

25. The apparatus of claim 24, wherein the end marker is included in a Service Data Adaptation Protocol (SDAP) header of the last data packet.

26. The apparatus of claim 24, wherein the end-marker is set if the QoS flow requires in-sequence delivery.

27. The apparatus of claim 24, wherein the set of instructions that, when executed by the processor, further cause the processor to set a start marker indicating a start of packets associated with the QoS flow scheduled to be transmitted through the second DRB in a first data packet associated with the QoS flow scheduled to be transmitted through the second DRB, in response to determining that no more data packets associated with the QoS flow remain to be transmitted through the first DRB or the first DRB was released; and
transmit the first data packet through the second DRB.

28. The apparatus of claim 24, wherein the set of instructions that, when executed by the processor, cause the processor to determine a Quality of Service (QoS) flow is remapped further cause the processor to:
receive the QoS flow Identifier and AS RDI in the downlink packets; and
detect the DRB associated with the QoS flow has changed.

29. The apparatus of claim 24, wherein the set of instructions that, when executed by the processor, cause the processor to determine a Quality of Service (QoS) flow is remapped further cause the processor to:
receive a RRC message of Radio Bearer Configuration; and
detect the DRB mapping provided in the RRC message is different from previous DRB mapping.

30. The apparatus of claim 24 wherein the set of instructions that, when executed by the processor, further cause the processor to:
receive a RRC message indicating the configuration of a radio bearer;
determine whether the QoS flows associated to the DRB requires in-sequence delivery;
enable end-marker mechanisms if in-sequence delivery is required and disable end-marker mechanism if in-sequence delivery is not required.

31. A method of wireless communication of a base station, comprising:
determining whether in-order delivery is required for a QoS flow;
receiving first one or more data packets associated with the QoS flow through a first DRB and receiving second one or more data packets associated with the QoS flow through a second DRB;
determining whether at least one of the first one or more data packets includes a data packet having an end marker indicating an end of packets associated with the QoS flow scheduled to be transmitted through the first DRB; and
sending the second one or more data packets to an upper layer subsequent to that the first one or more data packets are sent to the upper layer, in response to determining that at least one of the first one or more data packets includes the data packet having the end marker.

32. The method of claim 31, further comprising:
refraining from sending the second one or more data packets to the upper layer, in response to determining that none of the first one or more data packets includes the data packet having the end marker header field set.

33. The method of claim 32, further comprising:
determining whether at least one of the second one or more data packets includes a data packet having a start marker indicating a start of packets associated with the QoS flow scheduled to be transmitted through the second DRB, in response to determining that none of the first one or more data packets includes the data packet having the end marker; and
stopping the refraining and sending the second one or more data packets to the upper layer subsequent to that the first one or more data packets are sent to the upper layer, in response to determining that at least one of the second one or more data packets includes the data packet having the start marker.

34. The method of claim 33, wherein the determining whether the at least one of the second one or more data packets includes a data packet having the start marker comprises detecting the start marker in a Service Data Adaptation Protocol (SDAP) header of the at least one of the second one or more data packets.

35. The method of claim 31, wherein the determining whether at least one of the first one or more data packets includes a data packet having an end marker comprises detecting the end marker in a Service Data Adaptation Protocol (SDAP) header of the at least one of the first one or more data packets.

36. An apparatus for a wireless communication comprising:
a processor and a memory device coupled to the processor, the memory device containing a set of instructions that, when executed by the processor, cause the processor to:
receive first one or more data packets associated with a QoS flow through a first DRB and receive second one or more data packets associated with the QoS flow through a second DRB;
determine whether at least one of the first one or more data packets includes a data packet having an end marker indicating an end of packets associated with the QoS flow scheduled to be transmitted through the first DRB; and
send the second one or more data packets to an upper layer subsequent to that the first one or more data packets are sent to the upper layer, in response to determining that at least one of the first one or more data packets includes the data packet having the end marker.

37. The apparatus of claim 36, wherein the set of instructions that, when executed by the processor, further cause the processor to refrain from sending the second one or more data packets to the upper layer, in response to determining that none of the first one or more data packets includes the data packet having the end marker header field set.

38. The apparatus of claim 37, wherein the refraining is only performed if the QoS flow is determined as in-sequence delivery required.

39. The apparatus of claim 38 wherein the set of instructions that, when executed by the processor, further cause the processor to:
determine whether at least one of the second one or more data packets includes a data packet having a start marker indicating a start of packets associated with the QoS flow scheduled to be transmitted through the second DRB, in response to determining that none of the first one or more data packets includes the data packet having the end marker; and
stop the refraining and send the second one or more data packets to the upper layer subsequent to that the first one or more data packets are sent to the upper layer, in response to determining that at least one of the second one or more data packets includes the data packet having the start marker.

40. The apparatus of claim 39, wherein the set of instructions that, when executed by the processor cause the processor to determine whether the at least one of the second one or more data packets includes a data packet having the start marker further cause the processor to detect the start marker in a Service Data Adaptation Protocol (SDAP) header of the at least one of the second one or more data packets.

41. The apparatus of claim 37, wherein the set of instructions that, when executed by the processor cause the processor to determine whether at least one of the first one or more data packets includes a data packet having an end marker further cause the processor to detect the end marker in a Service Data Adaptation Protocol (SDAP) header of the at least one of the first one or more data packets.
